SEQUENCE LISTING (1 sequence)

SEQ ID NO: 1 - DNA, 57 bp, Unknown
  Examplary sequence for encoding and encryption process
acctgagtctggtcatggactgtgcacctgagtctggtcatcacctgtggactgtgc

(19) United States
(12) Patent Application Publication
(10) Pub. No.: US 2013/0246460 A1
(43) Pub. Date: Sep. 19, 2013

(54) SYSTEM AND METHOD FOR FACILITATING NETWORK-BASED TRANSACTIONS INVOLVING SEQUENCE DATA

(71) Applicants: Dan Maltbie, Sunnyvale, CA (US); Lawrence Ganeshalingam, Los Gatos, CA (US); Patrick Allen, Scotts Valley, CA (US)

(72) Inventors: Dan Maltbie, Sunnyvale, CA (US); Lawrence Ganeshalingam, Los Gatos, CA (US); Patrick Allen, Scotts Valley, CA (US)

(73) Assignee: ANNAI SYSTEMS, INC., Los Gatos, CA (US)

(21) Appl. No.: 13/629,567

(22) Filed: Sep. 27, 2012

Related U.S. Application Data
(63) Continuation-in-part of application No. 13/417,184, filed on Mar. 9, 2012.
(60) Provisional application No. 61/539,931, filed on Sep. 27, 2011.
(60) Provisional application No. 61/539,942, filed on Sep. 27, 2011.
(60) Provisional application No. 61/650,417, filed on May 22, 2012.
(60) Provisional application No. 61/662,996, filed on Jun. 22, 2012.
(60) Provisional application No. 61/451,086, filed on Mar. 9, 2011.

(51) Int. Cl. G06F 19/18

(52) U.S. Cl. CPC G06F 19/18
USPC 707/771

(57) ABSTRACT

A method of processing, transmitting, and otherwise facilitating network-based transactions involving, polymeric sequence information is disclosed herein. Systems and methods for facilitating uploading, downloading and other network-based transactions involving sequence information, such as large files of genomic sequence data are described. These transactions may involve communicating such large files of sequence information between entities such as, for example, genome sequence centers (GSCs), genome data repositories (GDRs), genome data analysis companies (GDACs) and or data coordination centers (DCCs).

### CROSS REFERENCE TO RELATED APPLICATIONS

The present application claims the benefit of priority under 35 U.S.C. §119(e) of U.S. Provisional Application Ser. No. 61/539,931, entitled SYSTEM AND METHOD FOR FACILITATING NETWORK-BASED TRANSACTIONS INVOLVING SEQUENCE DATA, filed Sep. 27, 2011, of U.S. Provisional Application Ser. No. 61/539,942, entitled SYSTEM AND METHOD FOR SECURE, HIGH-SPEED TRANSFER OF VERY LARGE FILES, filed Sep. 27, 2011, of U.S. Provisional Application Ser. No. 61/650,417, entitled METHOD AND SYSTEM FOR SECURE, HIGH-SPEED NETWORK-BASED STORAGE AND RETRIEVAL OF GENOMIC SEQUENCE DATA, filed May 22, 2012, and of U.S. Provisional Application Ser. No. 61/662,996, entitled SYSTEM AND METHOD FOR SECURE, HIGH-SPEED TRANSFER OF VERY LARGE FILES, filed Jun. 22, 2012, the contents of each of which are hereby incorporated by reference in their entirety for all purposes. This application is a continuation-in-part of U.S. patent application Ser. No. 13/417,184, entitled BIOLOGICAL DATA NETWORKS AND METHODS THEREFOR, filed Mar. 3, 2012, which claims priority to U.S. Provisional Patent Application Ser. No. 61/451,086, entitled BIOLOGICAL DATA NETWORK, filed on Mar. 9, 2011, the contents of each of which are hereby incorporated by reference in their entirety for all purposes.

### FIELD

This application is generally directed to processing polymeric sequence information, including biopolymeric sequence information such as DNA sequence information, and to transmission of such sequence information between locations within a network.

### BACKGROUND

Deoxyribonucleic acid (“DNA”) sequencing is the process of determining the ordering of nucleotide bases (adenine (A), guanine (G), cytosine (C) and thymine (T)) in molecular DNA. Knowledge of DNA sequences is invaluable in basic biological research as well as in numerous applied fields such as, but not limited to, medicine, health, agriculture, livestock, population genetics, social networking, biotechnology, forensic science, security, and other areas of biology and life sciences.

Sequencing has been done since the 1970s, when academic researchers began using laborious methods based on two-dimensional chromatography. Due to the initial difficulties in sequencing in the early 1970s, the cost and speed could be measured in scientist years per nucleotide base as researchers set out to sequence the first restriction endonuclease site containing just a handful of bases.

Thirty years later, the entire 3.2 billion bases of the human genome have been sequenced, with a first complete draft of the human genome done at a cost of about three billion dollars. Since then sequencing costs have rapidly decreased. Today, many expect the cost of sequencing the human genome to be in the hundreds of dollars or less in the near future, with the results available in minutes, much like a routine blood test.

As the cost of sequencing the human genome continues to decrease, the number of individuals having their DNA sequenced for medical, as well as other purposes, will likely significantly increase. Currently, the nucleotide base sequence data collected from DNA sequencing operations are stored in multiple different formats in a number of different databases. Such databases also contain scientific information related to the DNA sequence data including, for example, information concerning single nucleotide polymorphisms (SNPs), gene expression, copy number variations. Moreover, transcriptomic and proteomic data are also present in multiple formats in multiple databases. This renders it impractical to exchange and process the sources of DNA sequence data and related information collected in various locations, thereby hampering the potential for scientific discoveries and advancements.

### SUMMARY

This disclosure is generally directed to a method of processing, transmitting, and otherwise facilitating network-based transactions involving, polymeric sequence information. More particularly but not exclusively, in one aspect the disclosure describes systems and methods for facilitating uploading, downloading and other network-based transactions involving sequence information, such as large files of genomic sequence data. These transactions may involve communicating such large files of sequence information between entities such as, for example, genome sequence centers (GSCs), genome data repositories (GDRs), genome data analysis companies (GDACs) and or data coordination centers (DCCs). Each of these entities may be either public institutions privately owned or privately-owned enterprises.

The sequencing data involved in such transactions may be generated by, for example, a GSC, which receives a purified prep of a patient's chromosomal and or mitochondria DNA, or an RNA prep, for sequencing. The patient's identification will typically be anonymized with a series of codes to label the specific aliquot from a sample preparation and the organ, tissue or cell types. Furthermore, other information including but not limited to EMR data, clinical and pharmacological as well other network metadata that is specific to the particular patient can be collected by the DCCs but kept separate from the genomic data.

The sequence data that is generated by the GSCs may be provided to or otherwise transferred within a biological data network, which may also be referred to herein as a BioIntelligent or “bIQ” network. An exemplary bIQ network is described within, for example, ones of the above-referenced co-pending patent applications. Metadata relating to the sequence data may be collected and utilized during the processing of the sequence data throughout the bIQ network in order to, for example, facilitate data coordination, correlation, privacy, security, validation and authentication. These and other aspects of the disclosed system and method are described hereinafter.

In one particular aspect the disclosure is directed to a genome storage repository including a data repository. The genome storage repository includes a receive interface for receiving, from over a network, a plurality of portions of at least one file of biological sequence data conveyed over the network in accordance with a parallel file transfer process. The genome storage repository further includes a controller in communication with the receive interface and the data repository. The controller generates a reconstructed file of biological sequence data by reconstructing the at least one file of biological sequence data using the plurality of portions of the at least one file of biological sequence data.

In another aspect the disclosure is directed to a subscriber node operable within a biological data network. The subscriber node includes a receive interface for receiving, over one or more data links of the biological data network, a plurality of biological data units containing encoded genomic information wherein the encoded genomic information represents genomic information encoded relative to a reference sequence. The subscriber node further includes a controller for processing the plurality of biological data units.

The disclosure is also directed to a genome storage repository including a data repository containing encoded genomic information and biological information relating to the encoded genomic information. The genome storage repository also includes a controller for generating a plurality of data units containing the encoded genomic information and the biological information. A transmit interface operates to transfer the plurality of data units to a subscriber device over a network.

In yet another aspect the disclosure pertains to a node operable within a biological data network. The node includes a receive interface for receiving a plurality of data units from one or more data links of the biological data network wherein each of the plurality of data units includes a payload representative of encoded genomic information and a header representative of biological information relating to the encoded genomic information. The node further includes a data repository and a controller for storing the plurality of data units within the data repository.

In a further aspect the disclosure relates to a subscriber node having a receive interface for receiving, from over a network, an encrypted data unit containing encoded genomic information wherein the encoded genomic information represents genomic information encoded relative to a reference sequence using a plurality of instructions. The subscriber node further includes a controller for decrypting the encrypted data unit using a subscriber key.

The disclosure further pertains to a method which includes receiving, from over a network, a plurality of portions of at least one file of biological sequence data conveyed over the network in accordance with a parallel file transfer process wherein ones of the plurality of portions are transferred substantially simultaneously in multiple data streams. The method also includes generating a reconstructed file of biological sequence data by reconstructing the at least one file of biological sequence data using the plurality of portions of the at least one file of biological sequence data. The at least one file of biological sequence data is then stored within a data repository.

In another aspect the disclosure relates to a method which includes receiving, over one or more data links of a biological data network, a plurality of biological data units containing encoded genomic information wherein the encoded genomic information represents genomic information encoded relative to a reference sequence. The method further includes processing the plurality of biological data units and storing the plurality of biological data units within a memory unit.

In yet a further aspect the disclosure pertains to a method which includes establishing a data repository containing encoded genomic information and biological information relating to the encoded genomic information. The method further includes generating a plurality of data units containing the encoded genomic information and the biological information. The plurality of data units are then transferred to a subscriber device over a network.

The disclosure is also directed to a method which includes receiving a plurality of data units from one or more data links of a biological data network wherein each of the plurality of data units includes a payload representative of encoded genomic information and a header representative of biological information relating to the encoded genomic information. The method also includes storing the plurality of data units within a data repository.

In a further aspect the disclosure pertains to a method which includes receiving, from over a network, an encrypted data unit containing encoded genomic information wherein the encoded genomic information represents genomic information encoded relative to a reference sequence using a plurality of instructions. The method also includes decrypting the encrypted data unit using a subscriber key so as to generate a decrypted data unit and storing the decrypted data unit within a memory.

In another aspect the disclosure relates to a genome storage repository including a data repository containing encoded genomic information and biological information relating to the encoded genomic information. The genome storage repository includes a receive interface for receiving, from over a network, a processing request from an analysis node. The genome storage repository further includes a controller operative to process, in response to the processing request, at least the genomic information in accordance with an analysis program in order to generate analysis results. The genome storage repository may further include a transmit interface configured to transmit the analysis results over the network to the analysis node. In addition, the receive interface may be further configured to receive the analysis program from the analysis node.

In yet a further aspect the disclosure relates to a method which includes establishing a data repository containing encoded genomic information and biological information relating to the encoded genomic information. The method also includes receiving, from over a network, a processing request from an analysis node. In addition, the method includes processing, in response to the processing request, at least the genomic information in accordance with an analysis program in order to generate analysis results. The method may also contemplate transmitting the analysis results over the network to the analysis node and receiving the analysis program from the analysis node.

### BRIEF DESCRIPTION OF THE DRAWINGS

The present application may be more fully appreciated in connection with the following detailed description taken in conjunction with the accompanying drawings, wherein:

FIG. 1 illustratively represents a genome sequence data network incorporating a high capacity, high throughput networked-based genome storage repository (GSR).

FIG. 2 illustrates a first exemplary implementation of a genome sequencing center (GSC) configured to operate in a biological data network.

FIG. 3 depicts a second exemplary implementation of a GSC configured to operate in a biological data network.

FIG. 4 illustrates an exemplary implementation of a network-based genome storage repository.

FIG. 5 depicts a codec schema representative of various encoding, decoding, encryption, decryption and transcoding operations which may be effected within a biological data network.

FIG. 6 shows one manner in which a distributed conditional access system (DCAS) may be employed for the management of access to the data within a biological data network.

FIG. 7 illustratively represents the incorporation of a distributed conditional access system (DCAS) within an alternative data network.

FIG. 8 illustrates one manner in which the encode/decode and encrypt/decrypt schema described with reference to FIGS. 1-7 may be utilized to mediate genomic-based transactions among various users of a biological data network.

FIG. 9 is a flowchart of an encoding and encryption process which may be employed within a biological data network.

FIG. 10 illustrates a comparative sequence analysis process used to minimize apparent biological differences between a reference and a sample sequence entry.

FIG. 11 is a flowchart of an alternate encoding and encryption process capable of being employed within a biological data network.

### DETAILED DESCRIPTION

### System Overview and Workflow

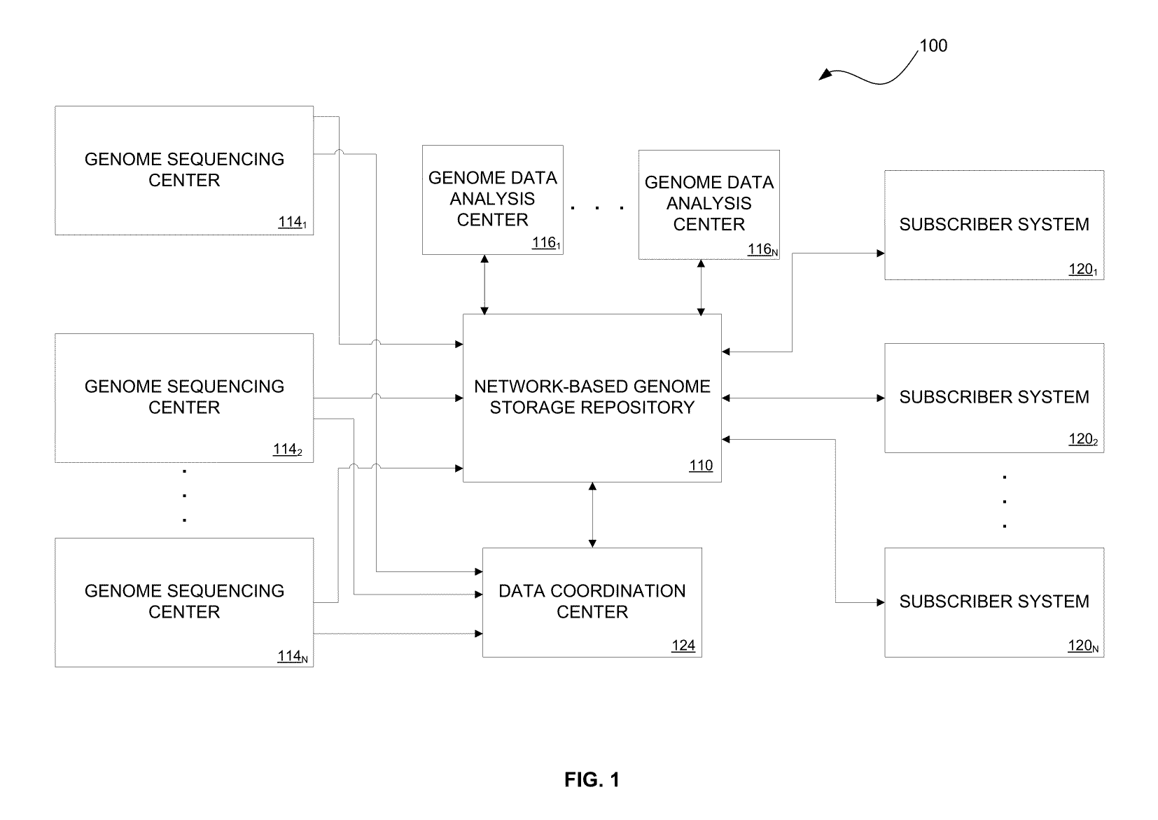

Attention is now directed to FIG. 1, which illustratively represents a genome sequence data network 100 incorporating a high capacity, high throughput networked-based genome storage repository (GSR) 110. The network may also be referred to herein as a bIQ network. The GSR 110, which contains genomic sequence data and related information, is in network communication with one or more genome sequencing centers (GSCs) 114, one or more genome data analysis centers (GDACs) 116, and one or more subscriber systems 120. In an exemplary embodiment such network communication is designed to take place over one or more existing wide area networks, such as the Internet. The GSR 110 may function as a central repository for the GSCs 114 to store, and GDACs 116 to retrieve, sequence data and associated metadata.

As is discussed below, a typical workflow scenario involving the network 100 may begin with submission of a tissue sample to a GSC 114 or associated institution for preparation of genome analyte. The workflow continues with DNA/RNA sequencing and characterization by a GSC 114 and upload of the resultant sequence data and related information to the GSR 110. In one embodiment the sequence data produced by the GSC 114 is produced in a BAM format or other conventional format and is transferred to the GSR 110 using the GeneTorrent™ techniques described in the above-referenced provisional patent application Nos. 61/539,942 and 61/662,996. At the GSR 110, the received BAM files may be encoded into the bIQ format described hereinafter and in the above-referenced patent applications. The bIQ-formatted data may then be downloaded to subscriber systems 120 using GeneTorrent™ techniques or otherwise made available for further processing by one or more genome data analysis centers (GDACS) 116.

In one embodiment the GSR 110 also synchronizes with a data coordination center (DCC) 124 or equivalent system configured to provide the primary coordination portal for researchers or other personnel involved with a particular research initiative, project or commercial endeavor. In general, the applicable DCC 124 maintains the higher-level study attributes and clinical data associated with each tissue sample. The GSR 110 will query the applicable DCC 124 to verify that submitted data is associated with a valid sample. The DCC 412 can also retrieve catalog information from an external source and allow users to perform queries across project, sample and sequence data.

Considering now the workflow of FIG. 1 in greater detail, a bio-specimen (e.g., a tissue sample) is furnished to one of the GSCs 114 (or to an associated institution such as a Biospecimen Core Resource) and used as the basis for preparation of a genome analyte. Aliquots of the analyte (e.g., DNA or RNA) are then provided to, or developed within, a GSC 114 for sequencing and characterization. The GSC 114 uploads the resultant sequence data and associated metadata to the GSR 110 and may transfer other metadata, e.g., Sample and Data Relationship Format (SDRF) metadata, to a project data portal provided by the DCC 124. Once stored within the GSR 110, the sequence data and associated data may be queried and downloaded by authorized personnel (e.g., researchers) associated with the GDACs 116.

During operation of the network 100, the GSR 110 will generally synchronize information, and otherwise coordinate closely, with the one or more DCCs 124 respectively providing coordination portals for various projects or groups of researchers. In an exemplary embodiment each of the DCCs 124 maintains the higher-level study attributes associated with at least one such project as well as clinical data associated with each sample. The GSR 110 will query the appropriate DCC 124 to verify that data submitted by a GSC 114 is associated with a valid sample. In certain embodiments some or all of the DCCs 124 may retrieve catalog information in order to enable users at the GDACs 116 to perform queries across project, sample and sequence data. In other embodiments queries from GDACs 116 will be received through a portal or other interface established by the GSR 110. In one embodiment the repository 110 consults an external user authentication database (not shown) in connection with authorization of users for uploading, downloading, and/or querying of sequence information. As is discussed below, users may be authorized for different roles with respect to different projects coordinated by the DCCs 124.

In one embodiment a unique ID (“UUID”) is assigned to each aliquot of the tissue samples provided to or processed by a particular GSC 114. The UUID may, for example, be included within anonymized metadata associated with each physical aliquot sample and electronically transmitted by the GSC 114 to the DCC 124. Such metadata may include, for example, information identifying the tissue source site, sample type, analyte type, patient ID, and other information characterizing the sample or the facilities/equipment used to obtain the sample. The DCC 124 then creates a new sample record based upon this metadata, which is associated with the UUID corresponding to the aliquot. This metadata can then be retrieved from the DCC 124 through, for example, a web interface which may or may not be provided by a data portal of the DCC 124.

The GSC 114 to which the sample is provided will perform sequencing and thereby generate BAM file(s), or other files of predefined type, containing the resultant sequence information. The GSC 114 then defines an analysis object (“Analysis object”), which in one embodiment includes a metadata file and the BAM files(s) corresponding to the metadata. The GSC 114 also assigns a UUID to the Analysis object. An upload client (described below) at the GSC 114 then initiates the sequence submission process by passing a user certification/session token and the submission metadata to the GSR 110 for validation. If validation is successful, the GSR 110 will create a database entry for the Analysis object and each of its constituent BAM files. As is discussed below, the GSR 110 will then track the status of the submission as it moves from loading, through any validation or transfer errors, until it is ready for download by a subscriber system 120.

In one embodiment each metadata file may include references to the UUIDs corresponding to all of the sequence data files (e.g., BAM files or other sequence data files of predefined type) and aliquots linked to the bio-specimen data (i.e., data related to the initial tissue sample) maintained within the DCC 124. Alternatively, this information may be included within a separate file which is independently provided by the GSC 114 to the GSR 110 as part of the sequence submission process. The GSR 110 may then verify that these UUIDs correspond to valid UUIDs stored within the DCC 124 before creating a corresponding submission record and UUID corresponding to each Analysis object (and potentially each individual BAM file of the Analysis object) to be uploaded. In addition, the sequence data associated with a given submission may be suppressed, and new sequence data can be submitted for the same sample. This may occur with respect to cases in which, for example, it is desired to “top off” a previous submission with more complete coverage.

In one embodiment the GSR 110 maintains a list of “valid” bio-specimens (e.g., tissue samples) for a particular project and regularly synchronizes this list to corresponding information maintained at the corresponding DCC 124. This enables the sequence information corresponding to a particular sample to be redacted at the GSR 110 in response to information received from the DCC 124. For example, if the owner of a particular tissue sample at some point revokes consent relating to the download of sequence information derived from the sample, such sequence information could be redacted at the GSR 110. In certain cases the metadata information associated with such redacted sequence information could be searched in response to queries submitted by subscriber systems 120 and/or GDACs 116, but the associated, redacted sequence information would not be available for download. In other embodiments only users of a subscriber system 120 having a certain authorization or subscription level would be permitted to download sequence information corresponding to metadata identified in response to a query received from such a system 120; that is, such sequence information would be appear to be redacted or otherwise suppressed or unavailable when identified in metadata returned in response to queries received from unauthorized users.

As is discussed below, in one embodiment the GSC 114 may utilize a high-speed, parallelized file transfer process to transfer the BAM file(s) associated with the Analysis object to the GSR 110. In one embodiment the BAM file(s) are encrypted using a key specific to the particular session in which the file(s) are transferred. The associated metadata, which will generally be included within an encrypted file of inconsequential size relative to the size of the Analysis object, may then be separately sent to the GSR 110 using a conventional file transfer process. At the GSR 110, the encrypted BAM files(s) are decrypted and the sequence data included therein is encoded into the biQ format for storage, typically together with all or part of the metadata. In response to a download request or query from a subscriber system 120, a substantially similar or identical high-speed, parallelized file transfer process may then be used to communicate the encoded sequence data and related metadata of interest the requesting system 120. In one embodiment the encoded sequence data and related metadata is encrypted using both a key specific to the particular session in which the transfer occurs and a key unique to the requesting subscriber system 120.

### Exemplary System and Component Architecture

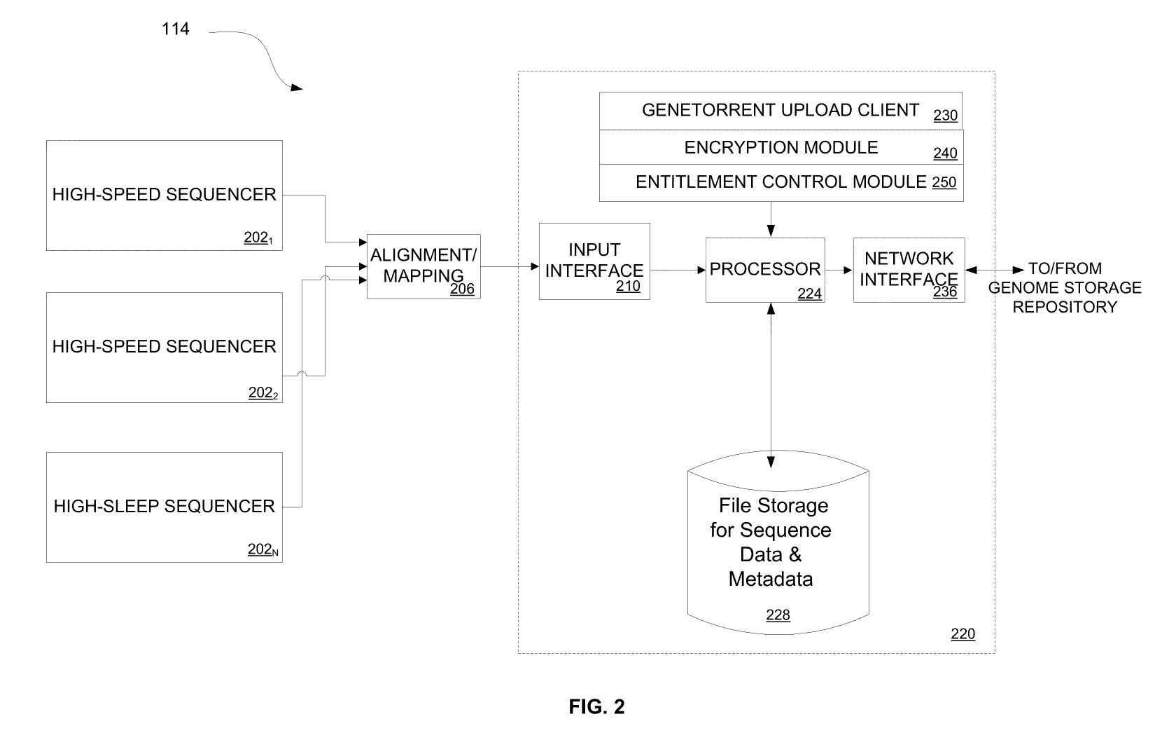

Attention is now directed to FIG. 2, which illustrates a first exemplary implementation of a GSC 114. One or more high-speed sequencing machines 202 are operative to generate sequence reads, which are then aligned and mapped to a reference sequence in alignment/mapping module 206. Variants may also be called. In one embodiment the module 206 produces BAM files comprised of sequence alignment data; that is, binary versions of sequence alignment/mapping (SAM) files.

The BAM files produced by the module 206 are provided to an input interface 210 of a processing module 220. A processor 224 operates to store the received BAM files along with related metadata within a file storage unit 228 and executes an encryption module 240 to encrypt this information using a key associated with, for example, a particular data transfer session. As is discussed in further detail below, the processor 224 executes the instructions of a GeneTorrent™ upload client 230 to transfer the BAM files within the file storage unit 228 to the GSR 110 via a network interface 236. In one embodiment the metadata stored within the file storage unit 228, which will typically be only a small fraction of the size of the associated BAM files, is transferred to the GSR 110 using conventional network transmission techniques.

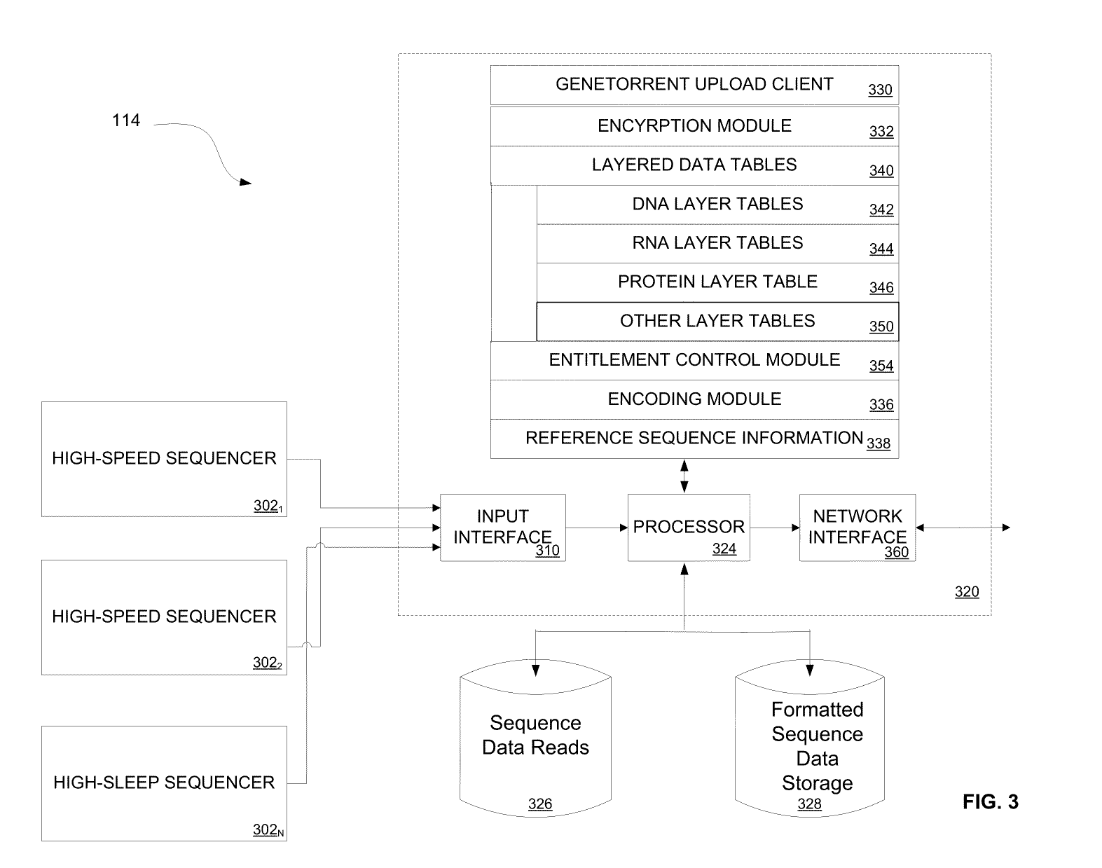

FIG. 3 depicts a second exemplary implementation of a GSC 114. As shown, one or more high-speed sequencing machines 302 are operative to generate sequence reads, which are then provided to an input interface 310 of a processing module 320. A processor 324 operates to store the received sequence data reads along with related metadata within a storage unit 326. In the implementation of FIG. 3, the processor 324 executes the instructions of an encoding module 336 in order to encode each sequence read (i.e., segment of biological sequence data) stored within the storage unit 326 into a formatted biological data unit comprised of a header and a payload (such format also being referred to herein as the bIQ format). As is described in above-referenced co-pending patent applications, the payload of each biological data unit may be representative of or contain an encoded representation of a segment of biological sequence data. In one embodiment this encoded representation comprises a set of instructions which are at least implicitly defined relative to a reference sequence 338. The header of each biological data unit may include biological or other information relating to the encoded information included within or represented by its payload. In one embodiment this header information includes information stored within one or more layered data tables 340. For example, the header information may include DNA-related information included within one or more DNA layer tables 342, RNA-related information included within one or more RNA layer tables 344, protein-related information included within one or more protein layer tables 346, or information from other layer tables 350.

In the embodiment of FIG. 3, the processor 324 stores the biological data units comprising encoded sequence information and related metadata within a file storage unit 328 and may execute an encryption module 332 to encrypt the biological data units using a key associated with, for example, a particular data transfer session. In alternative embodiments, the processor 324 may operate upon the sequence reads received from the input interface 310 to create biological data units substantially simultaneously with storing such reads within the storage unit 326. The processor 324 further executes the instructions of a GeneTorrent™ upload client 330 to transfer the biological data units within the file storage unit 328 to the GSR 110 via a network interface 360 in the manner described below and in the above-referenced copending patent applications.

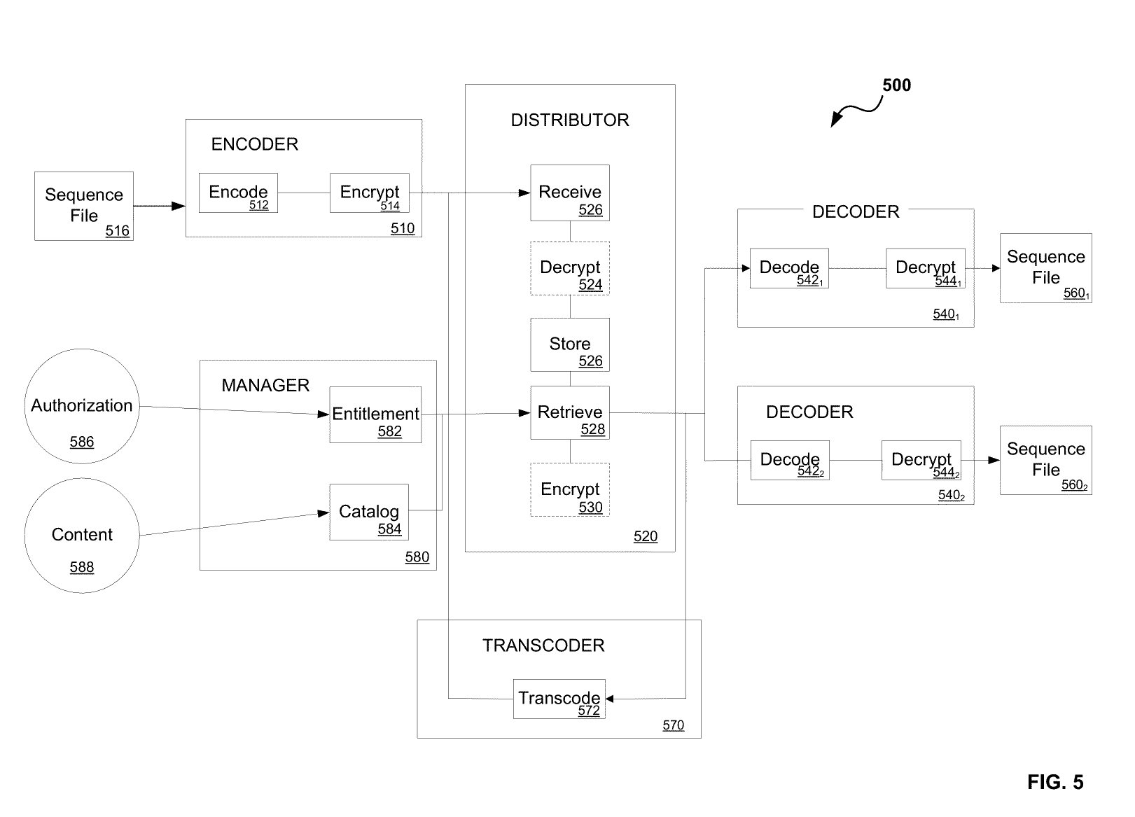

Thus, the disclosure contemplates that a GSC 114 may be configured to transfer, using a GeneTorrent™ upload client, either BAM files or encoded sequence information (i.e., biological data units) to the GDR 110 to enable distribution of the subject genomic information to subscriber systems. It should be appreciated that in embodiments in which the subject genomic information is encoded into biological data units at a GSC 114, an encoding process similar or identical to that described with reference to FIG. 3 may occur at the GDR 110. This approach is described below with reference to FIG. 5.

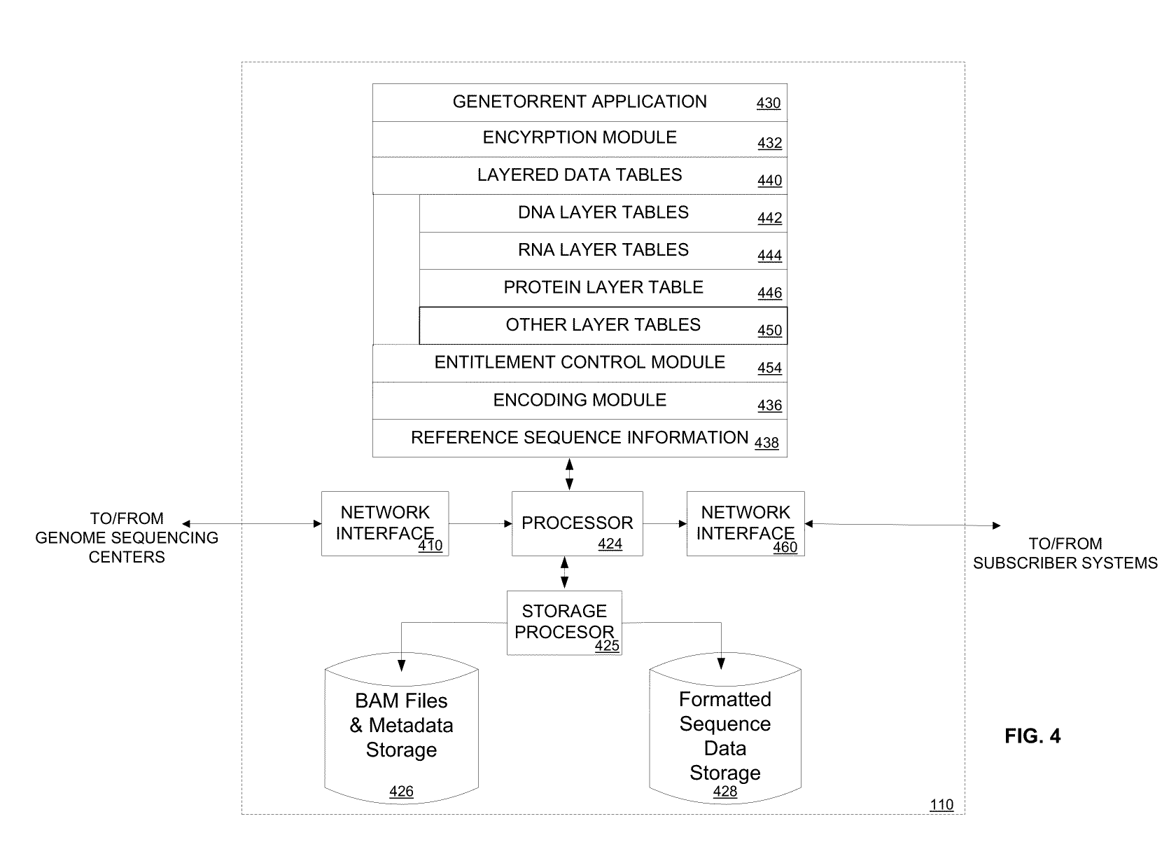

Attention is now directed to FIG. 4, which depicts an exemplary implementation of the GSR 110. In the embodiment of FIG. 4, the GSR 110 is configured to receive BAM files and related metadata from the GSCs 114. That is, in the embodiment of FIG. 4 it is assumed that the sequence reads from the sequencing machines within the GSCs 114 are not being encoded into biological data units prior to be transmitted to the GSR 110. In embodiments in which such biological data units are generated at the GSC 114, it would be unnecessary to include a similar sequence encoding capability within the GSR 110.

The GSR 110 includes an input interface 410 configured to receive the BAM files and related metadata transferred from a GSC 114. In order to facilitate this transfer a processor 424 of the GSR 110 executes the instructions of a GeneTorrent™ application 430 disposed to interact with the GeneTorrent™ upload client executed at the GSC 114. In one embodiment GSR 110 includes a storage processor 425 operative to store the received BAM files along with the related metadata within a storage unit 426. In the implementation of FIG. 4, the processor 424 executes the instructions of an encoding module 436 in order to encode each sequence read (i.e., segment of biological sequence data) stored within the storage unit 426 into a formatted biological data unit comprised of a header and a payload. As is described in above-referenced co-pending patent applications, the payload of each biological data unit may be representative of or contain an encoded representation of a segment of biological sequence data. In one embodiment this encoded representation comprises a set of instructions which are at least implicitly defined relative to a reference sequence 438. The header of each biological data unit may include biological or other information relating to the encoded information included within or represented by its payload. In one embodiment this header information includes information stored within one or more layered data tables 440. For example, the header information may include DNA-related information included within one or more DNA layer tables 442, RNA-related information included within one or more RNA layer tables 444, protein-related information included within one or more protein layer tables 446, or information from other layer tables 450.

The storage processor 425 stores the biological data units comprising encoded sequence information and related metadata within a file storage unit 428 and may execute an encryption module 432 to encrypt the biological data units using one or more encryption keys. For example, in one embodiment execution of the encryption module 432 effects encryption using both a key associated with a particular data transfer session and a key associated with the subscriber system to which the encrypted biological data units are being transferred. As is discussed further below, the processor 324 further executes the instructions of the GeneTorrent™ application 330 to transfer the encrypted biological data units within the file storage unit 428 to a GeneTorrent™ download client within the requesting subscriber system via a network interface 460.

### Exemplary Encoding, Encryption and Transcoding Approaches

Attention is now directed to FIG. 5, which depicts a codec schema 500 representative of the various encoding, decoding, encryption, decryption and transcoding operations which may be effected within the data network 100. As shown, the schema 500 includes an encoder 510 for performing an encode element 512 and an encrypt element 514 with respect to a file of sequence data 516. The file of sequence data 516 may be of, for example, a mapped format or a variants call format (VCF). In one embodiment the encoder 510 is representative of the encoding and encryption operations which may occur within a GSC 114 in a manner consistent with the present disclosure.

The encoder 510 may align and map sequence reads to a reference sequence and call variants. During this first stage the format of the data can be expected to be in many different formats and operated upon by several different versions of algorithms and analytical tools. In one embodiment the sequence data that is generated and processed by the encoder 510 is not yet accessible to other components of the data network 100 or to other biological networks in communication therewith.

In one embodiment the encode element 512 generates biological data units based upon the segments of sequence data 516 included within each file 516. As discussed above, each biological data unit may include a header containing information relevant to the sequence information encoded within the payload of the biological data unit. The headers of each biological data unit may comprise layers of annotation and other information and may effectively function as tags for the sequence information included within the files 516. Metadata may also be directly embedded with the sequence data included within the payloads of biological data units to enhance and facilitate data processing operations elsewhere within the network 100.

The schema 500 further includes a network-based distributor 520 configured to receive encrypted and encoded files or segments of sequence data for distribution to requesting subscribers. The distributor 520 may, for example, be representative of the functionality implemented within an exemplary implementation of the GSR 110. As shown, the distributor 500 includes a receive element 522 for receiving the encrypted and encoded sequence data transmitted by the encoder 510 over a network. A decrypt element 524 decrypts the encrypted and encoded sequence data and provides the unencrypted result to a storage element 526 for storage within the distributor 500. In response to a request or query from a decoder 540 (described below), a retrieve element 528 cooperates with the storage element 526 to retrieve the encoded sequence information corresponding to the request or query. An encrypt element 530 then encrypts the retrieved, encoded sequence information prior to transmission over a network to the requesting decoder 540. In one embodiment this encryption is performed using a first encryption key associated with the data transfer session in which the encoded sequence information is transmitted and a second encryption key specific to the requesting decoder 540.

As shown in FIG. 5, each decoder 540 includes a decode element 542 and a decrypt element 544 for decrypting and decoding, respectively, the encoded and encrypted sequence information received from the distributor 520. As a result of these operations each decoder 540 produces a file 560 of sequence data corresponding to a reconstructed version of one of the files of sequence data 516 provided to the encoder 510. Each decoder 540 may, for example, be representative of the functionality implemented within an exemplary implementation of a subscriber system 120.

Also included within the schema 500 is a transcoder 570 having a transcode element 572. The transcoder 570 is operative to add data to, or associate additional data with, the encoded sequence information managed by the storage element 526 of the distributor 520. In one embodiment such additional data may be created as a consequence of processing the encoded sequence data within the distributor 520 using analysis programs or tools provided to the distributor by the transcoder 570. In other embodiments such data may comprise new knowledge from analysis of the encoded sequence data conducted at the transcoder or new information added from network metadata analysis. In addition to or in lieu of being retained by the storage element 526 of the distributor 520, the results of the processing initiated by the transcoder 570 may be returned to the transcoder 570 for storage. The transcoder 570 may, for example, be representative of the functionality implemented within an exemplary implementation of a GDAC 116.

As shown in FIG. 5, the schema 500 further includes a data manager 580 configured with an entitlement element 582 and a catalog 584. The entitlement element 582 receives authorization information 586 and is responsible for enforcing conditional access control throughout the network 100. That is, the entitlement element 582 regulates access to the information within the files 516 distributed throughout the network 100.

In one embodiment the conditional access control effected by the entitlement element 582 is distributed among the elements of the network 100. This distributed approach may be desirable in view of the nature of the sequence data and metadata being conditionally accessed during the execution of transactions involving such information. For example, such data may include sensitive or other preferably private information concerning individuals associated with sequence information potentially available throughout the network 100 and throughout systems linked to the network 100. In such case a distributed approach to regulating access to such sensitive information may be advantageous since data access may be controlled at multiple points within the network 100.

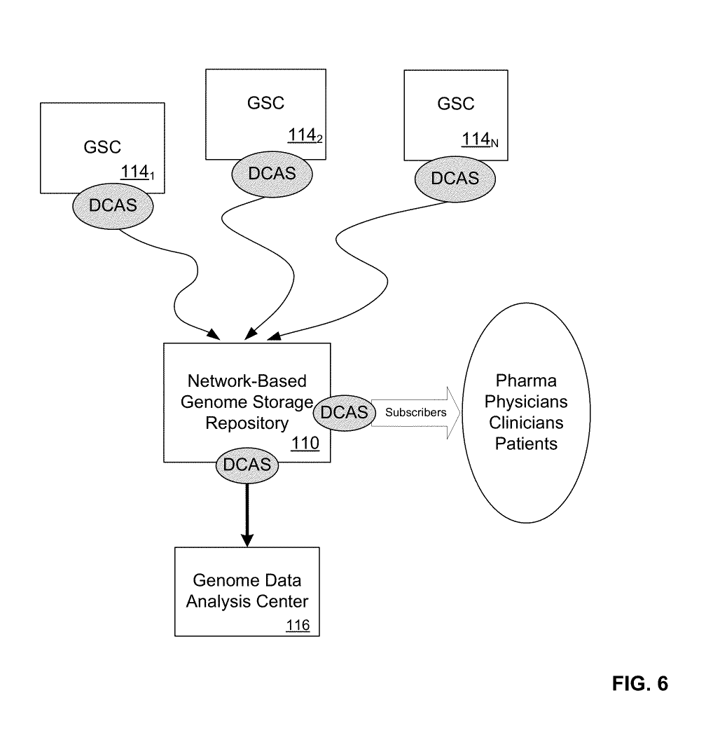

Attention is now directed to FIG. 6, which illustratively represents the incorporation of a distributed conditional access system (DCAS) within the network 100. In an exemplary embodiment users on the network 100 are authenticated using a system of highly distributed conditional access points. This may involve, for example, using an encoder to perform high speed pattern matching in a manner that is consistent with the standardized compression and encryption format. The encoder is able to efficiently couple these two processes together for best compression with highest security.

Regardless of the sequencing platform that is used by a GSC 114, the data may be formatted in such a way that it can be used in a standard compression and encryption format that is consistent with all GSCs approved for medical and pharmaceutical grade sequencing.

As shown in FIG. 6, a distributed conditional access system (DCAS) may be employed for the management of access to the data within the network 100. Such access may be based on, for example, a combination of qualifications including, without limitation, a consent requirement, medical or health alerts, analytical reports, updating the data with current findings and social reports. To the extent the sequence data is encoded in a common format when communicated on the network 100, conditional access of the sequence data may be effected at each and every transaction point. Development of such a common format could, for example, be based upon input provided by various agencies, individuals and institutions.

The rationale for a common format for encode and encryption of biological sequence data is based on the desire for an electronic mechanism that facilitates authorized transactions of information exchange involving human genomic and transcriptomic data as related to deep evaluation and analysis of these data types.

In one embodiment digital rights management will be mediated by the DCAS. The general specifications of rights management could be developed to be consistent with, for example, regulatory guidelines set by a genotype and phenotype expert group or other organization. For example, such guidelines may specify those authorized to access the stream of germline variants versus those authorized to access somatic variants files. One aspect of such guidelines could address an individual's rights with regard to genome sequence data, while another aspect could focus upon gene differential expression from RNA-Seq data.

The common format will preferably be optimized to encode and encrypt this data and will provide guidelines to regulate transmission and storage of this highly sensitive data. For example, in one embodiment the encryption scheme should involve granularity to the extent where access to any component of the data can be filtered and regulated to the N^{th} degree in order to enable various levels of user accessibility.

In one aspect, the disclosed system provides for the highest level of privacy by utilizing an approach to access control that is highly-distributive and easily regulated at nearly every transaction point. For example, conditional access control functionality should be present at the GSC 114 where sequence data is produced. The particular GSC 114 generates genome sequences for many different research groups, consortiums, research projects, clinics, pharma and individuals and all of this data will be sent to different places. The various data consumers will have different levels of access to the dataset. A typical scenario might involve a case where one GDAC 116 is entitled to view all sequence variants, somatic and germline combined while another might be entitled to access somatic mutations only.

In one embodiment an encrypted content key, Key_{c} may be generated for one set of genome sequence data files and separate subscriber keys, Keyₛ, generated for subscribers having different levels of entitlement to access the data.

For example, the data might be sent directly from a GSC 114 and post processed to a GSR 110. The source of this data will require access from multiple subscribers and different types of results will be published to several orders more destinations. The GSR 110 may be equipped with DCAS as a main transaction point for regulation of queries, subscriptions, publishing and function request.

In one embodiment the genome data transaction system provides a sequence data validation service which uses network-wide data coordination protocols.

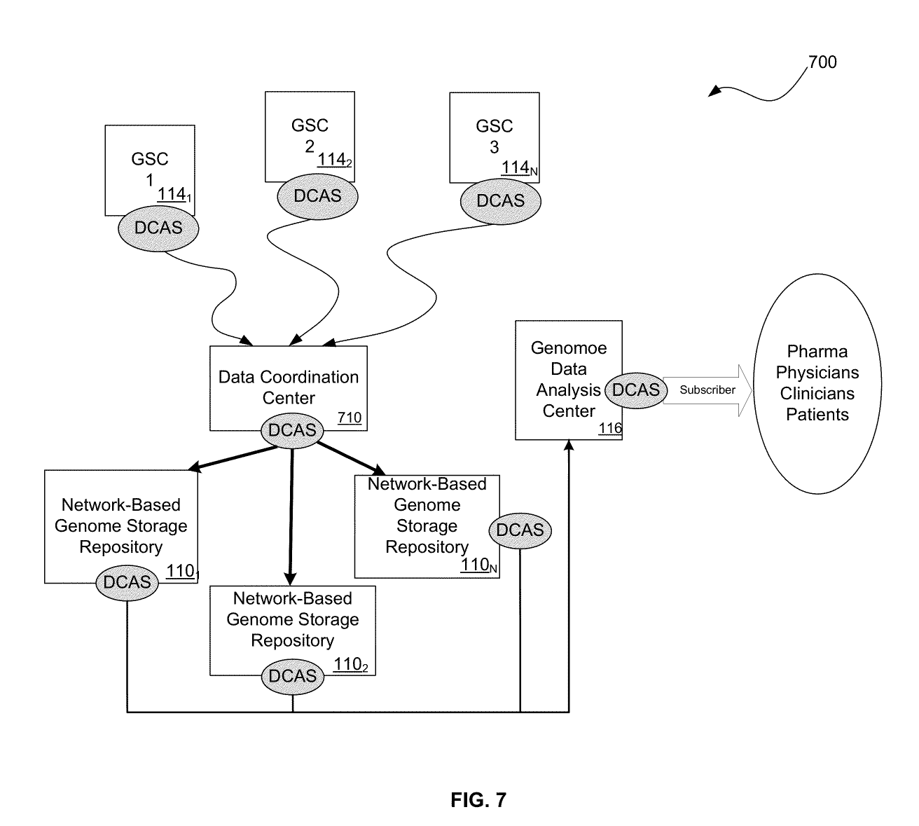

FIG. 7 illustratively represents the incorporation of a distributed conditional access system (DCAS) within an alternative data network 700. The network 700 is similar to the network 100, but includes multiple network-based genome storage repositories 110 linked to a data coordination center (DCC) 710. In addition, subscriber systems are disposed to query and interface with a GDAC 116 rather than with a GSR 110. It should be appreciated that other variations of the architecture of the network 100 are within the scope of the disclosure.

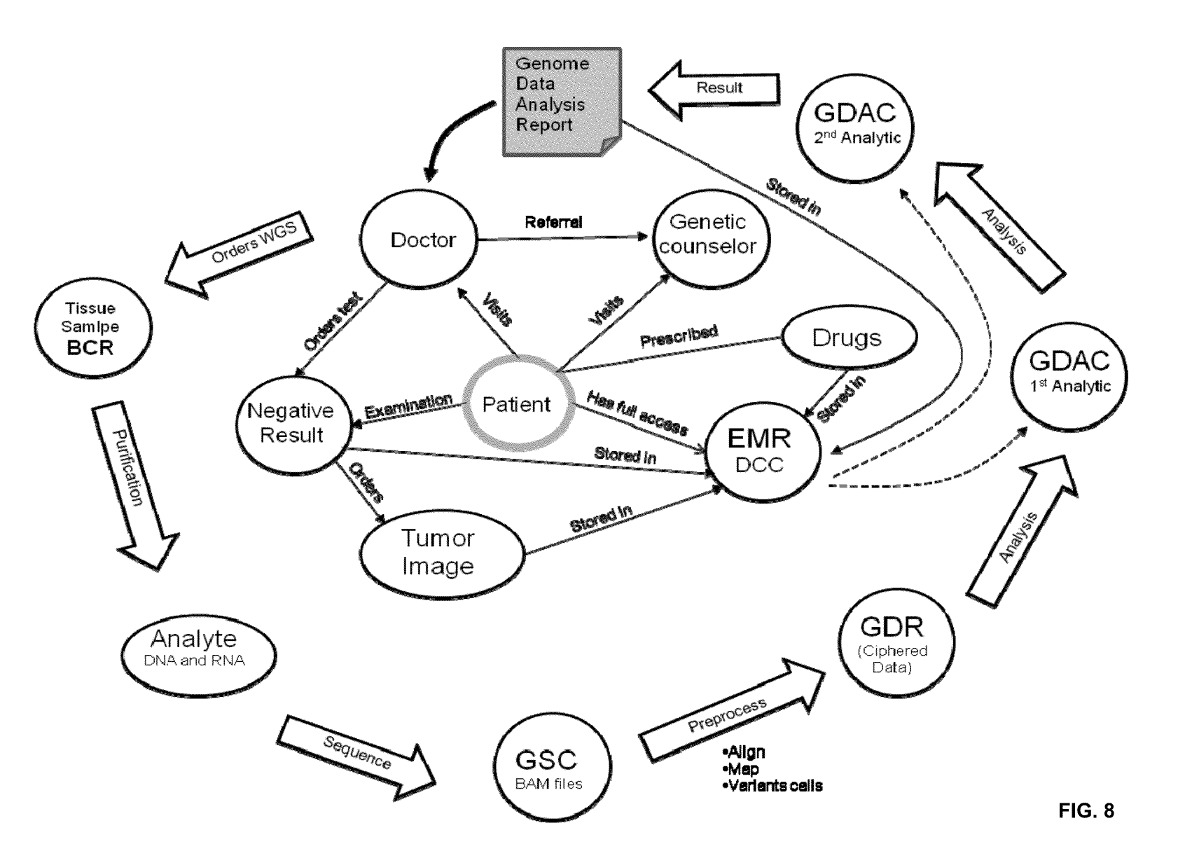

Turning now to FIG. 8, an illustration is provided of one manner in which the encode/decode and encrypt/decrypt schema described with reference to FIGS. 1-7 may be utilized to mediate genomic-based transactions among various users of the network 100. As was described with reference to FIGS. 1-7, data that is presented to a GSC 114 in a BAM format or any other format capable of being encoded into the bIQ format may be efficiently transmitted to a remote location within the network 100. One advantage of the biQ format is that the data can be operated upon in the compressed format, which obviates the need for conversion between a format suitable for compression and one optimized for processing and/or data security.

In one embodiment the GSC 114 receives various aliquots of highly purified analytes containing preparations of genomic and mitochondrial DNA and RNA. Using the several different sequencing platforms DNA-Seq and RNA-Seq data is generated. The GSC 114 will generally store the raw sequence reads in the format of the platform or machine generating the reads (e.g., within BAM files). The GSC 114 will also typically store the metadata for such platform or machine, information relating to the operator, the date of the sequence run, and other related information. This metadata information can be incorporated into biological data containing the compressed and encoded sequence data, which are then generally encrypted prior to being transmitted from the GSC 114 to the GSR 110 or, in other embodiments, to a GDAC.

The encoder device utilized in the GSC 114 may be comprised of hardware and software configured in a manner that is capable of processing BAM files at the rate of the stream. The encoder preferably matches dictionary word patterns and uses a compression and encryption scheme that enables secure transmission and entitlement management of the transactions that involves this data. In this regard the codec model of FIG. 5 provides a mechanism for commercial transactions involving transmission, exchange and analysis of genome sequence data.

For example, a doctor that is treating a cancer patient that is a difficult case can simply order a genome data analysis report (GDA Report) using a process that is similar to ordering a blood chemistry report today. In this case, based on symptoms and an assessment from a genetic counselor, the doctor may order a whole-genome sequence data analysis. The entire process can be medicated by the system described herein, with contractual relations involving the various entities being indicated in the outer layer of FIG. 6.

The workflow of FIG. 6 may be summarized as follows:
An oncologist experiences difficulty treating a cancer patient
Tumor image and other clues suggest genomics
Patient is sent to a genetic counselor
Results suggest whole genome data analysis report (GDA Report)
Doctor orders whole genome sequence (WGS)
Tissue sample is taken at a biospecimen core resource (BCR) facility
Purified genomic DNA is sent to genome sequencing center (GSC)
The raw reads data that is produced at the GSC is aligned, mapped and variants calls are made
The preprocessed is compared against other preprocessing data and metadata to insure the highest quality processing
Processed WGS are passed through a series of genome data analysis centers (GDACs) for various analysis and correlation studies
The results are aggregated and review by specialized medical expert and a short meaning genomic data analysis report (GDA Report) is prepared and present to primary doctor
Once the GDA Report has been prepared, it may be integrated into the patient's EMR
The analysis that is carried out at the GDAC may involve access to the patient's EMR or relevant information from EMR
GDACs may also have access to certain relevant drug interaction databases to generate highest quality GDA reports
Oncologist or other doctor can now make personal genome-based medical decisions

The present approach enables a high level of data protection and coordination from the time of a doctor's decision that a patient's genome data and other molecular markers may be relevant to the treatment of the patient. This scheme provides a first-in-kind mechanism to offer a genomic data electronic transaction model with state of the art entitlement management system.

At this stage, the information that is contained in a full genome data analysis report along with information from the EMR and the various metadata can be used to populate a semantic database and linked with other data such as but not limited to research publications, off-label drug data from pharmaceutical companies, drugs in the development pipeline, upcoming drug trials, communications between experts and other such related information of any type that might be relevant to the case.

The organization of the various types of data will allow meaningful usefulness of the vast amount of data that can be integrated into a medical decision making process.

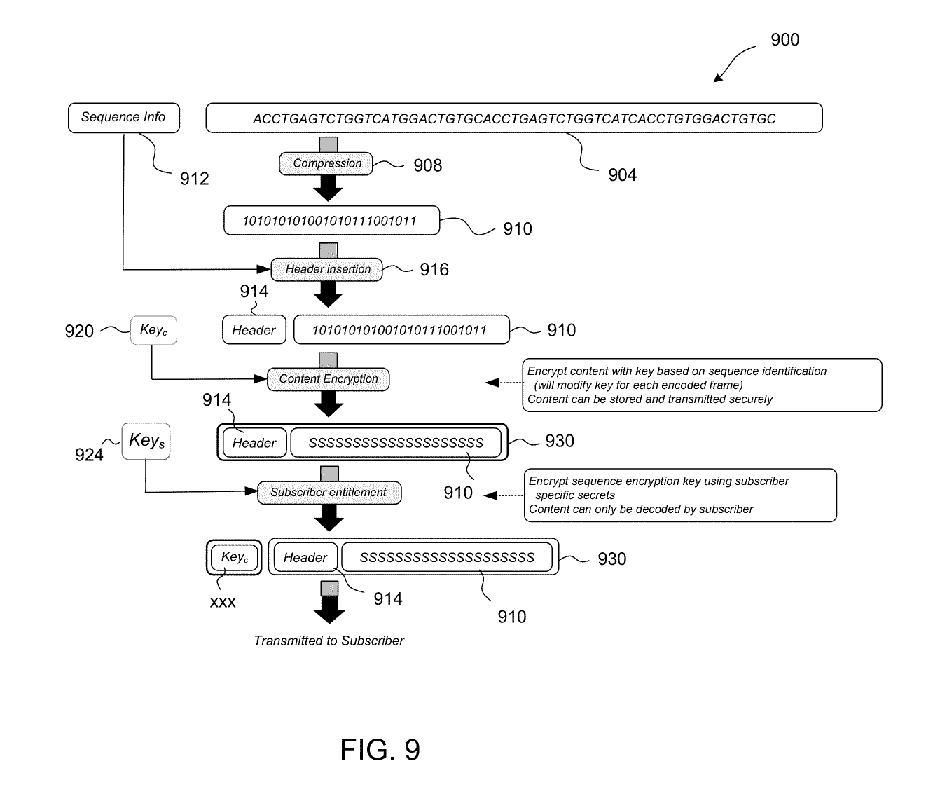

Attention is now directed to FIG. 9, a flowchart is provided of an encoding and encryption process 900 which may be employed within the network 100. As shown, sequence data 904 is encoded/compressed into the payloads 910 of biological data units (stage 908). Biological and other information 912 specific to the sequence information is used as the basis of headers 914 inserted such biological data units (stage 916). In one embodiment each header 914 includes information relating to a different layer of a biological data model associated with the sequence information. For example, the type of information that could be embedded and interwoven with the sequence data in the form of headers 914 (or as annotations within the payload of each biological data unit) could include, for example and without limitation, information concerning genotype, gene expression levels, methylation, microRNA interactions, drug response, clinical, environmental and any such relate annotation specific to the sequence files. See, for example, U.S. patent application Ser. No. 13/223,071, entitled “METHOD AND SYSTEMS FOR PROCESSING POLYMERIC SEQUENCE DATA AND RELATED INFORMATION”; U.S. patent application Ser. No. 13/223,077, entitled “METHOD AND SYSTEMS FOR PROCESSING POLYMERIC SEQUENCE DATA AND RELATED INFORMATION”; U.S. patent application Ser. No. 13/223,084, entitled “METHOD AND SYSTEMS FOR PROCESSING POLYMERIC SEQUENCE DATA AND RELATED INFORMATION”; U.S. patent application Ser. No. 13/223,088, entitled “METHOD AND SYSTEMS FOR PROCESSING POLYMERIC SEQUENCE DATA AND RELATED INFORMATION”; U.S. patent application Ser. No. 13/223,092, entitled “METHOD AND SYSTEMS FOR PROCESSING POLYMERIC SEQUENCE DATA AND RELATED INFORMATION”; and U.S. patent application Ser. No. 13/223,097, entitled “METHOD AND SYSTEMS FOR PROCESSING POLYMERIC SEQUENCE DATA AND RELATED INFORMATION”, each of which was filed on Aug. 31, 2011 and is incorporated by reference herein for all purposes.

In one embodiment much of the information that is layered on top of the raw sequence data will comprise annotations and other biologically intelligent information that is known today. As the bIQ network is developed and utilized it is anticipated that analytics builders and others at GDACs and other institutions will likely be substantial suppliers of new information that can be added to existing layers of the data model. Alternatively or in addition, such new information could comprise entirely new information types that could be layered into the existing model, or instead referred or pointed to as additional sources relevant information.

For example, analysis may review new variants risk correlations data, or drug efficacy and response data. In the case of the former it may be useful to have that layer of information packaged with the sequence data because of the specificity and pertinence as well as this might be information that is referenced regularly. In the latter case it might be more reasonable and efficient to include the detailed drug data as well as other drug relationships in a linked drug database.

Again referring to FIG. 9, in one embodiment a content encryption key (Key_{c}) 920 is generated based upon the content of the data and a subscriber key (Keyₛ) 924 is separately generated for each of the authorized users that have permission to access the data. For example, the Key_{c} may be derived from a package of the header 914 and the sequence data of the biological data unit 930 being transferred (e.g., the sequence data included within the received BAM or VCF file). The biological data unit 930 comprised of the header 914 and payload 910 is encrypted using the Key_{c} (stage 934) and is further encrypted using the Keyₛ (stage 938). Keeping the data secure and accessible only to those with the proper authority and under the set of specified conditions will involve the use of a set of encryption keys that will be issued to the users. Secret decryption keys are generated and transmitted separately to subscribers as part of a public-private key set.

Finally, the encrypted biological data unit 930 and public content key Key_{c} are transmitted from the GSC 114 to the GSR 110 and/or GDAC 116, and subsequently to a user of a subscriber system 120 (e.g. to a researcher, doctor, patient, etc.).

### Sequence Compression, Encoding and Encryption

Disclosed herein is a description of a biologically-intelligent nucleic acid sequence compression data format capable of being used in, for example, the bIQ network described above with reference to FIGS. 1-9. In one embodiment this data format is specifically designed for highly efficient compression, processing, movement, transmission and security of large volumes of DNA and RNA sequences.

Human genome sequences are 99.9% similar between individuals. If an ideal case scenario is considered then the whole genome sequence processing and transmission can be carried out with a 1000 fold less data by operating only on the difference in the data files.

For example, consider the case where the only differences between genomes were single base substitutions that are separated by hundreds and thousands of other bases. In this case, deletions and insertions do not exist and this would necessarily mean that there are no inversions or chromosomal translocations when a comparative sequence analysis of two individual genomes is carried out.

If this was the case, all reads would be mapped reads. In addition, compression performance would be of several orders of magnitude and lossless. Since this is far from reality, a reliable compression algorithm should consider substantially all types of structural variations in the sequence from simple indels (insertions and deletions that involve a small number of bases) to tens of thousands or millions of bases, that can be genomic or exogenous, involved in major primary sequence structural variations.

### Sequence Compression

Early approaches to compressing nucleic acid sequences convert the four letters into a binary format. In this regard the sequence alignment map (SAM) files can be converted to a binary (BAM) format with a much smaller footprint for storage. Recent approaches to compression uses a reference sequence and a variant call format (VCF) and other methods for taking advantage of having a reference sequence and leveraging the difference in the sequences (CRAM).

In one implementation of the compression method described herein, a dictionary approach is used to generate a reference sequence and to then determine the delta between this sequence and the sequence(s) being compressed. In one embodiment biological knowledge is integrated into the compression scheme using operation codes. For example, insertions and deletions that may represent thousands of bases can be represented by a single opcode instruction.

The bIQ format disclosed herein and in the co-pending patent applications referenced herein facilitates the integration of knowledge concerning a sequence into its representation in order to improve compression and meaningful processing of the data. For instance, a base at any given position in a sequence can be substituted by any of the other three bases. However, in every case of a base substitution one of the 3 options has a significantly different biological impact than the other two.

The observation is that single base substitutions resulting in termination of translation are mostly caused by transversions. Thus transition mutations leading to a truncated protein product with negative effects are far less likely. An alternative way to consider this is that translation stop codons are important in defining the correct mature C-terminal end of proteins.

### BAM File Format

The bIQ network facilitates the transmission of, for example, the sequence data generated by DNA and RNA sequencing processes. These sequencing processes generate files of various file formats including, for example, the BAM, CRAM and VCF format. In one embodiment the bIQ network is capable of receiving sequence data in any of these file formats. Sequence Alignment/Map (SAM) files are the precursors of BAM files, which are essentially a binary version of SAM files. The SAM file that is generated from sequencing run is a TAB-delimited ASCII format consisting of an optional header section and a telemetric sequence data section for the raw read sequences streaming from the sequencing machine.

BAM Header Fields

The header information that is associated with BAM files is typically attached at the head of the sequence data. The lines in the header start with a ‘@’ sign, while alignment lines do not. There are several different types of header lines with specific fields contained within each line.

For example, ‘@HD’ is usually the first line in the BAM files to indicate the start of the header lines in the file. The ‘@HD’ line of the header will usually have an information field for the version number of the file format being used (VN) as well as the sorting order of the alignments (SO). The coordinates for alignments are keyed and sorted by the reference sequence name field (RNAME) as well as the base position field (POS).

The next set lines in the BAM header are usually the lines that represent the reference sequence dictionary which are the lines that contain the information that defines the alignment sorting order of the BAM file. These lines are indicated by a ‘@SQ’ line. Each of these lines has six information fields.

For example, in the BAM file header from the Broad Institute shown below, the first field in the @SQ line is the (SN) which is the field that contains the reference sequence name. Each line in the file should have a different identifier for this field. This is an information field in the header of BAM files that is used in the alignment record in RNAME next position (PNEXT) fields which is a major coordinate sort key. In the exemplary header used from the Broad chromosome numbers, X, Y and Mito are some of the tags that are used in this field.

The balance of the information fields in the @SQ line include the reference sequence length (LN), the URI for the sequence file (UR), the identification of the genome assembly that was used (AS), the MD5 checksum without spaces (M5) and the species that the sequence maps to (SP). It is interesting to note that Epstein-Barr virus is one on the species sequenced in the current example.

The next line in the header is the read group indicated by ‘@RG’ which includes several information fields. Much of the sequence machine metadata can be associated with these header lines.

These lines include an identification number (ID). If there are multiple read group lines in the BAM file header then each line should have a unique id number. In addition, the @RG line includes the sequencing technology or platform (PL) that was used to generate the sequence. This may include but is not limited to Illumina, SOLiD, IONTORRENT, PACBIO and others.

The platform unit (PU) is a unique identifier for the actual unit used. The reference sequencing library that is used to calibrate the analyte concentration is found in the field for the library is denoted by LB and the date as well as the time of the run by indicated by DT. The sample identifier and the genome sequencing center are by SM and CN, respectively.

The program lines in the header ‘@PG’ contain the information fields for the program identification field (ID) in the program lines. Multiple program lines may exist in the BAM header and each would require a unique program ID. The program name (PN) command line (CL) and the version number (VN) fields might be included on this header line.

Example BAM Header

The following is a header from an exemplary BAM file.

| | | |
|---|---|---|
| @HD | VN:1.0GO:none | SO:coordinate |

| @SQ | SN:1 LN:249250621 | | |
|---|---|---|---|
| | UR:http://www.Theinstitute.org/ftp/pub/seq/references/Homo_sapiens_assembly19.fasta | | |
| | AS:GRCh37 | M5:1bxxxx0xxx1xxx2xxx3128 | SP:Homo Sapiens |

| @SQ | SN:2 LN:243000073 | | |
|---|---|---|---|
| | UR:http://www.Theinstitute.org/ftp/pub/seq/references/Homo_sapiens_assembly19.fasta | | |
| | AS:GRCh37 | M5:a0xxx1xxx2xxx3xxx4e | SP:Homo Sapiens |
| @SQ | SN:3 LN:198022430 | | |
| | UR:http://www.Theinstitute.org/ftp/pub/seq/references/Homo_sapiens_assembly19.fasta | | |
| | AS:GRCh37 | M5:fxxx1xxx2xx3xxxx32e5 | SP:Homo Sapiens |

| @SQ | SN:NC_000005 | LN:00023 | |
|---|---|---|---|
| | UR:http://www.Theinstitute.org/ftp/pub/seq/references/Homo_sapiens_assembly19.fasta | | |
| | AS:NC_007605.1 | M5:6xxxx1xxxx2xxxx20a | SP:Epstein-Barr virus |

| | | | | |
|---|---|---|---|---|
| @RG | ID:70004.7 | PL:illumina | PU:70xxx0xxx1xxx25.7 | LB:Solexa-57546 |

| | |
|---|---|
| DT:0xxx1xxx2xxx300-0500 | SM:000-111-xxx-222 CN:TI |

| | |
|---|---|
| @PG ID:GATK TableRecalibration | VN:100.100.2 CL:default_read_group=null |

default_platform=null force_read_group=null force_platform=null window_size_nqs=5
homopolymer_nback=7 exception_if_no_tile=false solid_recal_mode=SET_Q_ZERO
solid_nocall_strategy=THROW_EXCEPTION recal_file=/seq/picard/ABCD0123/C1-
000.111.222.xx.37/Solexa-55.444.33.222.recal_data.csv output_bam=null
preserve_qscores_less_than=5 smoothing=1 max_quality_score=50 no_pg_tag=false
fail_with_no_eof_marker=false skipUQUpdate=false Covariates=[ReadGroupCovariate,
QualityScoreCovariate, CycleCovariate, DinucCovariate]

### CRAM Format

There are a number of considerations relevant to the compression of nucleic acid sequence information including, without limitation, footprint, processing feasibility, efficient movement between memory elements, transmission or network and security.

There exist several potential approaches to dealing with problems attributable to the processing and storage of the voluminous amount of data expected to accompany the growing number of whole genome sequences being submitted to the public databases: 1) add more storage capacity, 2) discard some of the high-volume data (“triage”), and 3) compress the stored data using a highly efficient lossless algorithm.

Long term archiving and distribution of DNA samples worldwide is a complex operation to coordinate, with significant costs in physical storage, shipping and end-point sequencing. One additional option for dealing with increasing sequencing data is compression.

Compression of DNA sequence can leverage certain biological characteristics such as, for example, content of repetitive sequences and the comparative relationship to other known sequence. For example, CRAM is a new and efficient method for raw DNA sequence data storage using reference-based compression. This reference sequence based compression technique would likely be suitable and sufficient if sequence variation were limited to single nucleotide polymorphisms. In that case, all sequence entries would be identical length and compression, multiple sequence alignments, comparative sequence analysis and processing would be a lot easier to handle.

Although the CRAM method uses a reference for compression, it should be appreciated that the reference is suboptimal in that it is only used to compress on the order of 70% of the generated sequence reads. Moreover, the algorithm is lossy in that some read sequences are not compressed or encoded whatsoever.

### Variant Call Format (VCF) Version 4.1

The Variant Call Format (VCF) is a file format that is used to store the most prevalent sequence variations of various types. The current version is VCF 4.1, which involves mutation types, including single nucleotide polymorphisms, short insertions and deletions as well as larger and more complex structural variants. In addition, these files typically contain rich a set of sequence specific annotations.

VCF files are usually stored in a compressed format that can be indexed for fast and efficient random access to data when retrieving information on variant alleles from any position on the reference genome.

In order to interrogate these files, a stack of software called “VCFtools” is used to implement various utilities for processing including, for example, for slicing, merging, inter-leaving, performing format validation, comparing, annotating and performing basic statistical correlations. VCFtools and the genome analysis toolkit (GATK) developed by The Genome Sequencing and Analysis Group (GSA) in Medical and Population Genetics at the Broad Institute also provide a general Perl and Python API.

It is important to note that there are several tools that are used for mutation and variant calling. The different approaches use BAM files or other sequence read data as input for calling multiple various types of variants. Some are specific to a particular sequencing platform while others may be used across different platforms. Some tools call specific variants and other call multiple types of variants.

In one embodiment it is expected that all the variant calls will be uploaded in a VCF 4.1 format. However, the alignments and mutation calls could potentially be performed with several different tools using different probabilistic approaches to detecting sequence variations. The output data is then used to generate a VCF file for submission.

VCF Header Description

Like BAM files, the VCF file is comprised of a header and a body section. Both file types are reference-based, which is instrumental for navigating the base sequence data. However, whereas the focus of BAM files is to capture a substantial amount of information concerning the sequencing of a sample, the VCF file concentrates on the differences between the reference and sample sequence.

In the case of VCF files, the header is flexible and extendable with regards to the type and amount of metadata it contains. VCF files are highly-annotated to the extent that they may apply to a particular variant, as a whole or to each genotype. In addition to genotypic annotations, others that are commonly used may include filters, genotype quality score, genotype likelihoods, dbSNP membership, haplotype data, ancestral allele, mobile element information, read depth, mapping quality and other such related information.

### Optimization of a Reference Sequence

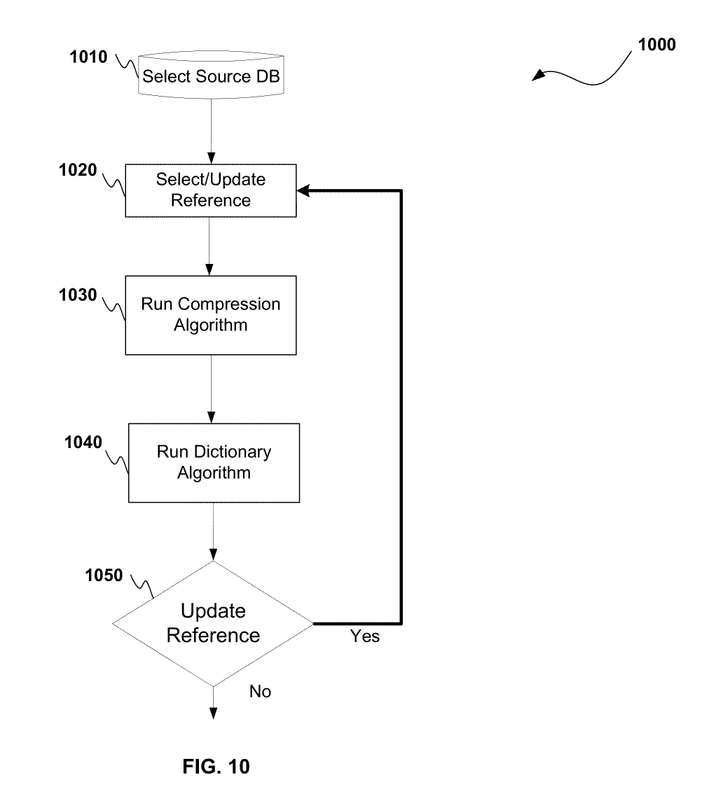

Attention is now directed to FIG. 10, which illustrates a comparative sequence analysis process 1000 used to minimize apparent biological differences between a reference and a sample sequence entry. As shown, during a first stage 1010 of the process 1000 a source database is selected having sequence entries all within the same species. Next, one entry within the database is selected (stage 1020). The biQ compression algorithm is then executed using by applying the reference sequences against the source database (stage 1030).

A dictionary compression scheme is then executed in order to identify features which may be used to update the selected reference sequence and thereby enable higher compression of the sequence entries (stage 1040). For example, stage 1040 may involve executing the compression algorithm to create a variants profile for each of the entries within the database and analyzing the resulting variants file. Such an analysis could include, for example, determining if the majority of the entries within the database have the same sequence polymorphisms.

For example, the selected sequence entry may have a nucleotide base that is an “A” at a particular location, but the majority of the entries may instead have a “G” at the specified location. The resulting variants data would indicate a transition instruction at that location (as opposed to a transversion which would result in a T or C substitution).

In the next stage 1050, the selected reference sequence is updated with the result of the data analysis described above. For example, in the scenario described above a “G” would be placed at the specified position. After the updating of the reference sequence, stages 1020, 1030 and 1040 are repeated until it is determined (in stage 1050) that further updating of the reference sequence is unlikely to yield further improvements in compression. This may be determined by, for example, comparing the current reference sequence to the dictionary entries and determining whether any changes to the reference would enhance compression performance. That is, the reference sequence will essentially be reduced to a sequence having a minimum number of mutations or structural variants.

In addition to the instant updating of reference sequence, modifications may be made to the type of information that is collected and maintained in the headers of these sequence files (e.g., BAM and VCF sequence data formats).

When the syntax for validation and verification of sequence files is updated, corresponding adjustments are made to the data verification protocol. The updating of reference sequence information is synced with any metadata and annotation changes that may occur in the various layer of information related to the data.

It should be appreciated that other compression theories could be employed where compression is achieved without having a reference as the basis for retaining highly-redundant sequence information. Compression techniques that are not reference-based can be applied to the data set and this can be coupled with an encryption schema that is consistent with the proposed codec model. For example, a dictionary approach could be used as part of a compression scheme in combination with other methods for compression that would achieve a suitably compressed dataset that optimized for security, privacy, IO and transmission.

In addition, there could be more than one selected reference sequence used for compressing the same set of sequence data. The particular reference sequence being referred to, will be specified in the instruction database entry. For example, if there were two control references and entry one referred to reference #1 while entry two referred to reference #2. The given set of bits in each entry would be the reference sequence ID, where number represents the controlled sequence number.

The sequence that is used to calibrate the data need not be selected from one of the entries. It could simply be generated or initially assigned by looking at the common entry for each of the positions. For example, if at position 100 more than 50% of the entries have a C then the reference should have a C at that position. In order to develop the minimum reference sequence, substitute a C for recursive optimization of the ideal sequence used for referencing. Doing this for the most common variants would find that the ideal minimum sequence would generate a highly-compressed database of mapped and unmapped raw reads.

### Operation Code Function

It should be understood that a large percentage (i.e., approximately 70%) of the raw reads from existing next-generation sequencing machines are mapped reads while the remaining 30% of the reads cannot be mapped. The CRAM algorithm efficiently compresses the mapped reads, and then performs de novo assembly to align, map and compress the pool of unmapped reads.

In contrast, when using the bIQ opcode instruction method (disclosed in the co-pending applications referenced herein) to compare the sequence elements present in one sample versus another, the compression algorithm will expand to include more advanced operations. In this way the algorithm becomes increasingly diverse with regard to biological relevance and the details of the operation for that comparison of the DNA sequences. For example, when two sequence entries are compared with each other there is an opportunity to take advantage of how they relate to each other to improve the algorithm. Two sequences that are compared have similarities and differences that can become intimately involved in operation coding of DNA sequence data. For example, in this case one sequence as relates to the other allows for one entry to serve as the control reference sequence. This provides an opportunity to use this method to compress the relative differences using biological instructions.

The information that is known about the nature and phenotypic outcome of a structural variant in the sequence can be useful in enhancing the quality and extent of a compression scheme. For example, certain chromosomal rearrangements (known translocations) or well-defined large deletions or insertion of readily identifiable viral DNA sequences may be integrated into compression as a single compression element.

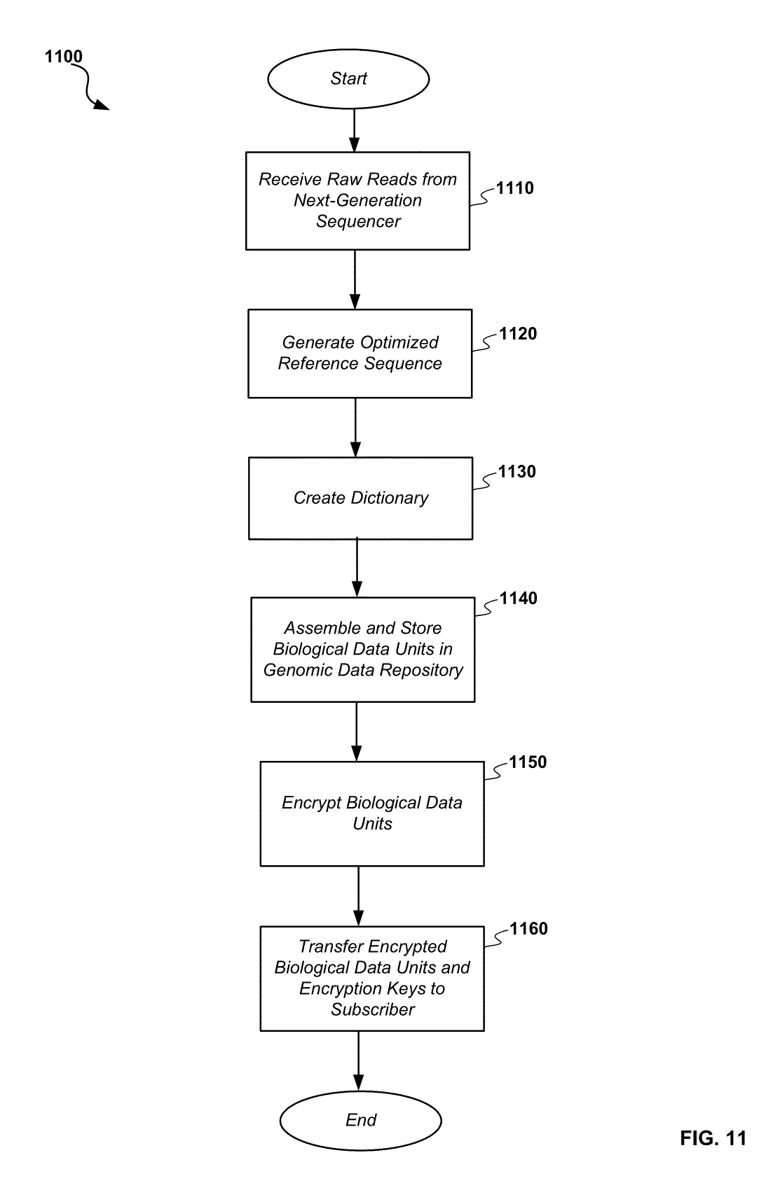

Referring now to FIG. 11, a flowchart is provided of an alternate encoding and encryption process 1100 capable of being employed within the network 100. The process 1000 employs the dictionary compression and reference sequence modification techniques described above. In an initial stage 1100, sequence reads are received from a next-generation sequence machine. An optimized reference sequence is then generated from these sequence reads (stage 1120). To the extent the approach described above with reference to FIG. 10 is used to generate the optimized reference sequence, a dictionary is created (stage 1130). Based upon this optimized reference sequence, biological data units are encoded, assembled and stored within a GSR (stage 1140). The stored biological data units are then encrypted (stage 1150) prior to being transferred to a subscriber system (stage 1160).

With regard to optimization of the reference sequence (stage 1120), deletions or insertions can be applied to the selected minimum reference sequence as an updated version for improved compression. Consider truncations as deletions at the 3′ end of a gene or in other words a premature termination codon (PTC) in the middle of the coding sequence resulting in a protein or polypeptide product with a shortened carboxyl terminus which usually does not function normally or might have toxic effects in the cell. In addition, a specific control reference sequence based on a minimum delta value may be selected, and then a dictionary may be generated from the resulting dataset. For example, all the minor variant alleles in BRCA1 gene (not limited to any one gene) that correlates with all known clinical and pharmacological effect can be used in a dictionary scheme.

Each mutation event within each sample entry that results in a phenotypic effect, as well as silent mutations that are common in several entries, can be placed in a dictionary using this approach for further compression of the sequence data. As a result, the algorithm is able to take advantage of specific difference values from the references that are common to multiple entries.

### Genetorrent™ Data Transfer

As was indicated above, sequence files generated by a GSC 114 may be securely transferred to the GSR 110 in parallel fashion through the GeneTorrent™ data transfer application. In the embodiments of FIGS. 1-5, this application is instantiated as the GeneTorrent™ application 430 installed on the GSR 110 and the GeneTorrent™ upload client 230 installed on a GSC 114. For operation involving data downloading, the GeneTorrent™ application 430 cooperates with a GeneTorrent™ download client installed on a subscriber system 120.

In upload mode, the GeneTorrent™ application 430 and a GeneTorrent™ upload client 230 cooperate to effect submission of a set of one or more sequence data files (e.g., BAM files) to the GSR 110. In one embodiment effecting such a submission involves adding the submission to one or more catalogs maintained by the GSR 110 and/or DCC 124, verifying the associated metadata to be uploaded, storing and indexing the metadata for search, storing the sequence data in replicated persistent storage within the GSR 110, and setting access rules based on, for example, consent agreements associated with the tissue samples from which the sequence data files are derived.

In download mode, the GeneTorrent™ application 430 and a GeneTorrent™ download client within a subscriber system 120 cooperate to retrieve a bundle of one or more sequence data files from the GSR 110. In one embodiment retrieving a sequence data file from the GSR 110 includes verifying the requesting user is authorized to view the data within the file, storing the sequence data in local persistent storage at the subscriber system, and verifying that the transfer was performed correctly.

In both the upload and download modes, the actual transfers of the sequence data files are preferably authenticated (i.e., only users associated with the appropriate permissions relative to the file may access its sequence data) and authorized (i.e., only users authorized in view of project-specific or other rules maintained by the GSR 110 and/or DCC 124 are permitted to download the identified sequence data file). Such transfers are also preferably secured in that the sequence data is strongly encrypted when transiting the network and reliable (i.e., files may be presumed to have been transferred essentially intact and uncorrupted unless the GeneTorrent™ application provides an indication to the contrary).

In one embodiment each GeneTorrent™ client provides a command line interface to the end user. Through this interface one of two operating modes typically may be invoked: upload and download. When operative in upload mode, the GeneTorrent™ client operates in concert with the GeneTorrent™ application 430 to upload files to the GSR 110. When operative in download mode, the GeneTorrent™ client and the GeneTorrent™ application 430 cooperate to download files to the client from GSR 110. In addition, the GeneTorrent™ application 430 may enter an “actor” mode during which multiple GeneTorrent™ server instances are created for use in performing parallel transfers to/from the GSR 110.

During operation of the system 100, the GeneTorrent™ application 430 executes on one or more application processors to manage file transfers to from GeneTorrent™ clients at GSCs 114 and to/from GeneTorrent™ clients at GDACs 116. In one embodiment multiple GeneTorrent™ server processes executing on the application processors listen for download requests, and multiple GeneTorrent™ upload actor instances are spawned when an upload request is received from a GSC 114 (or, in certain cases, from a GDAC 116). In the present embodiment, application server instances (“AppServer Instances”) executing on the application processors may be configured as either GeneTorrent™ upload actor instances or GeneTorrent™ download actor instances. The allocation of AppServer Instances among GeneTorrent™ upload and download actor instances may be made in accordance with, for example, the number and type of upload and download requests received from peer GeneTorrent™ instances at the GSCs 114 and GDACs 116. For example, during periods in which a higher number of download requests are received from GDACs 116 relative to the number of upload requests from GSCs 114, more of the AppServer Instances executing on the application processors may be configured as GeneTorrent™ download actor instances. Conversely, more of the AppServer Instances executing on the application processors may be configured as GeneTorrent™ upload actor instances during times in which a relatively larger number of upload requests are received. The system dynamically load balances across the application processors to allocate capacity for multiple upload and download processes, allowing it to better respond to the normal fluctuations in GSC and GDAC workflows. Moreover, performance with respect to a particular GeneTorrent™ upload or download session may be enhanced by allocating a relatively larger number of GeneTorrent™ actor instances to such process.

### File Submission

In an exemplary embodiment Analysis objects are the primary container for submitting and downloading sequence data. Each Analysis object may include one or binary sequence Alignment/Mapping (BAM) files and is associated with an XML metadata file. The payload of each BAM file contains both the sequencing data (in bases, quality scores, and read names produced by the sequencing instrument) and read placements with annotations about strand, alignment, and quality features. Raw sequence read files, such as .srf files, can also be submitted along with the BAM files. In the exemplary embodiment each data submission includes a file of submission metadata compliant with the SRA 1.3 XML schema.

When making a new data submission a user will create and save a user authentication key via an authentication Web page hosted by or in association with the GSR 110. The user may then invoke an application executed by the GSC 114 to create a unique identifier (UUID) to associate with the Analysis object. Assigning a UUID to the Analysis object ensures that the submission can be subsequently uniquely identified relative to all other submissions provided to the GSR 110. The user may then create a directory at the GSC 114 and copy the XML metadata file (e.g., “analysis.xml”) and sequence data files relating to the Analysis object into the directory. In one embodiment such sequence data files may include additional files of type other than BAM, such as legacy formats or proprietary formats containing raw read data. For example, the RNA-seq raw read data could be submitted along with the alignment data in the BAM. In one embodiment these additional files will be uploaded, stored and downloaded along with the BAM file as part of the same Analysis object.

In one embodiment the GSR 110 maintains a list of users permitted to upload new submission sequence and metadata. This list may be maintained by, for example, an out-of-band interaction between personnel representing each GSC 114 and operations staff of the GSR 110. Specifically, the user name (and optionally a project group) will be identified within the GSR 110 as the owner(s) of the associated sequence data files. This enables a check to be performed during the submission process to confirm that the user's group membership matches or is otherwise appropriately associated with the GSC 114 from which the submission is being received (e.g. users associated with GSC “BI” can only submit metadata for centername=“BI”). If a user requests modification or suppression of a submission (thereby making the associated sequence data file(s) unavailable for download), the GSR 110 will verify that the user is a member of the group that owns that submission.

Once a user has been authenticated (i.e. proven to be who they say they are), access to sequence data may be further constrained by applicable project consent authorization constraints. For example, consents from owners of sequence data relating to those users eligible to download such data may be received by the GSR 110 in one or more files on a regular (e.g., daily) basis. The GSR 110 may then update one or more internal authorization tables to reflect any changes. In one embodiment each file of sequence data within the GSR 110 is associated with a project coordinated by the DCC 124 through the identifier (e.g., UUID) assigned to the biospecimen from which the sequence data file was derived. The GSR 110 may receive this tag as part of the sequence data submission process. In one embodiment the GSR 110 may then confirm with the DCC 124 that the identifier is valid. The DCC 124 may also provide information on whether the sample has been redacted.

### File Upload

As is discussed below, uploading of a new submission of sequence-related data generally involves several operations. First, the user at the applicable GSC is authenticated and the submission “package” of files to be uploaded is validated. Next, the Analysis object with associated metadata is added to a repository catalog associated with one or both of the applicable DCC 124 and the GSR 110. The set of one or more sequence data files included within the submission package are then transferred to the GSR 110. The correctness of the transfer may then be verified, and its legitimacy may be confirmed with reference to information maintained within the DCC 124. The upload process is then generally concluded by setting appropriate authorizations for access to the information within the new Analysis object.

During an upload session, a user will typically transfer a plurality of files related to sequencing of a sample to the GSR 110. For example, in one embodiment these files, which are all associated with the same Analysis object, may include one or more XML files containing metadata about the sequence data files of interest. The Analysis object may, but need not, also include one or more sequence data files (e.g., BAM files) associated with the metadata.

In one embodiment the GeneTorrent™ upload client 230 will first pass the XML metadata files of the Analysis object to the GSR 110, where consistency checks and other types of validation will be performed. During this stage all necessary validation is performed in order to ensure that the metadata and BAM file headers are complete and correctly formatted. The GSR 110 will validate the structural metadata required to identify and manage the sequencing data and may also perform any project-specific validation rules required to ensure consistency between the metadata and BAM headers. In the event such validation is successful, a metadata client module at the GSC will generate a manifest.xml file that can be passed to the GeneTorrent™ client 230 for use in uploading the sequence data files of the Analysis object to the GSR 110. In the event that errors are found in the submission, in one embodiment a complete error log will be returned with descriptive errors to help isolate the failures.

If the metadata upload is successful, the GeneTorrent™ client 230 will locate all of the sequence data file(s) (e.g., BAM file(s)) listed in the analysis.xml file within the directory created during the submission stage. Next, the GeneTorrent™ client 230 will connect to an API provided by the GSR 110 and pass a GeneTorrent™ object file (“GTO), which is used by a GTO Executive™ subsystem to initiate the upload. The GTO Executive™ subsystem will identify the address of the upload user and generate the required digital certificates. Once this has occurred the GTO Executive™ subsystem will spawn multiple GeneTorrent™ upload actor instances, which will begin uploading a first of the one or more sequence data files listed in the analysis.xml file. In particular, the GeneTorrent™ upload client 230 then segments the file and begins parallel file transfer sessions of the file pieces over SSL. The GeneTorrent™ protocol will manage transmissions errors on any of the file pieces and will reassemble the file at the GSR 110.

Once the transfer is complete, the GSR 110 will perform a series of validation steps prior to making the data available for download. In one embodiment these steps may include, for example, computing the MD5 checksum and comparing it against the value in the XML metadata file, verifying the name of the transferred sequence data file matches the name in the XML metadata file, and validating that the headers of the transferred sequence data file match the header information in the XML metadata file. In one embodiment the DCC 124 will be queried to determine if the sample is valid and is in an active state (e.g. has not been redacted). If the sample cannot be found, the state will be set to “verifying sample”. If the sample is found, but has been redacted, the state will be set to “suppressed”. In both cases, the GSR 110 will periodically poll the DCC 124 to see if the state has changed.

### File Download

In one embodiment a two-phase process is used to download the biological data units of files associated with Analysis objects within the system 400. Namely, during a first phase one or more sequence files of interest are identified, and during a second phase the biological data units associated with the identified sequence files are transferred from the GSR 110 to a subscriber system 120 and/or GDAC 116 for storage. For each Analysis object, the GeneTorrent™ file transfer application 430 will coordinate retrieval of related metadata from the metadata database 512 during the first phase and the biological data units of all associated sequence data file(s) from the GSR 110 during the second phase.

During the first phase, a user may issue a metadata-related to query to the GSR 110. In an alternate embodiment such queries are directed to the DCC 124. The user may specify values for one or more metadata attribute fields within the query. In response, the GSR 110 may respond with zero, one, or more URIs referencing Analysis object(s) having metadata matching the specified attribute values. Users may search for the most commonly accessed attributes by name (e.g. “disease_type=OV”), or may use free-form searches for text strings within the XML metadata file provided as part of the sample submission.

During the second phase, the URIs may be passed to a GeneTorrent™ download client at the subscriber system 120 or GDAC 116 for storage. Next, the GeneTorrent™ download client 524 interacts with at least the GeneTorrent™ application 430 to transfer the identified sequences. Finally, optional validation checks are performed by the GeneTorrent™ download client to ensure proper download and content format.

Further details concerning the GeneTorrent™ data transfer process are provided in the above-referenced provisional application Nos. 61/539,942 and 61/662,996, which are hereby incorporated by reference in their entirety for all purposes.

### Data Coordination, User Authentication and Conditional Access

### Data Coordination

Today there exist systems capable of, for example, coordinating the identification of a patient with a code (barcode) for the tissue taken from that patient. This tissue is used to prepare DNA for sequencing. The DNA sequences are used to generate sequence files which are given universal identification numbers (UUIDs).

The above-referenced content-aware bIQ network provides a system to partition all of the different types of data in such a way that is functionally consistent with the way that it is done currently. As is described herein, such a network may also be further configured to facilitate tracking, integrating and coordinating (e.g, from birth) substantially all of a person's relevant electronic health information including next-generation genomic and other omics data from highly distributed databases in a single step.

Consider a case for a difficult cancer patient. Today, a doctor takes a sample of tissue from the patient and labels it and ships it to the Biospecimen Core Resource (BCR) where it is assigned a secure barcode associated with patient X. Once the DNA or RNA is purified and sent to the GSC, the barcode is converted to the unique ID used by researchers and analysts to coordinate the sequence with other data including metadata of several types.

In contrast, a doctor with access to the content-aware bIQ network uses one integrated system that is capable of monitoring and coordinating all of these different data types. The process of coordinating the data is obviated by the content-aware network. As an example, it may currently require several months to institute desired changes to a file containing genomic sequence data (e.g., an update to the header of a BAM files at a data coordination center). As a result, the not-yet-coordinated data sits in a staging area and not accessible to interested users at a GDAC. In contrast, the bIQ network enables coordination of networked genomic data in a number of different ways. For example, changes to a reference sequence, or modification of the format that is used to store and transmit the sequence data, can be easily facilitated by the bIQ network.

### Correlation of Sequence Data with Phenotypes

Consider a network which is configured in such a way that even though databases are geographically dispersed and contain different types of data with varying levels of accessibility correlation analysis can be carried out.

For example, there are currently over 650 different genes that have been associated with Alzheimer's disease. The gene commonly known as ApoE has been shown to be important in onset and progression of the disease and in particular the epsilon 4 allele.

Since all of the data that is accessible on the network can be easily located and the content is known it would be simple to make queries on special population data and generate high confidence statistical data. For example, how many subjects with 2 copies of ApoE epsilon 4 alleles also have minor allele variants in a given set of other associated genes and also have a certain range score on mild cognitive impairment tests.

A network user with relevant algorithms at a GDAC may wish to send a query to find of those subjects with the ApoE marker how many had been treated with a particular drug for a different illness involving overlapping biological pathways. This might be an off-label drug that could be highly effective for treating certain type of stage of Alzheimers.

The metadata that is available on the network should be made useful in making statistical corrections to determine confidence in finding any correlations can be made with MCI scores or brain images (MRI, PET, etc.). All of this data will be distributed across the network and results are aggregated to publish a result.

Another level of correlation of this data may exist when DNA and RNA are prepared at various BCRs by different technicians and sequenced at different GSCs on different platforms and mapping and variants calling done by different tools correlations analysis can be done to establish a standard of quality. For example, are certain machine errors increased at a certain GSC at certain times the day or when a particular technician is working.

Correlations can be done on essentially any on data point available on any individual. For example, if enough data was available on the network it would be reasonable to extract meaningful correlations from nutritional, environmental and other such data with genomic sequence data.

### Controlling Privacy of Data on bIQ

In an exemplary embodiment, data that is stored on the bIQ network is partitioned a manner that is consistent with maintaining the highest level of privacy of data.

For example, the network may be configured to permit individuals to be able to give dynamic consent to anyone requesting access to their molecular expression and genomic sequence data that is kept at a GDR.

In this case, an individual's data might be stored at a GDR and each query request for access to that particular set of files would alert the owner of the data (the patient). The owner can grant access to the data using several different bIQ network compatible devices including but not limited to a cell phone.

Privacy is also enhanced by the manner in which the relevant data will be compressed and encrypted for transmission and to facilitate other transactions. For example, certain data that is intended to stay private can be encrypted and compressed in a manner that is consistent with generating different levels of privatized genomic variants data.

Finally, data on the network can be accessed and processed by moving applications to the stored data rather than by moving the data from storage or otherwise copying the data. In this case, data can be accessed or information about the data can be conditionally accessed by network queries by authorized users.

For example, the privacy of the data can be controlled, partitioned and filtered based on many features including but not limited to the type of the variant SNP versus indels versus copy number variations versus chromosomal rearrangements.

In addition, alternative splicing variants, triplet expansions, repeat sequence, methylation profile and other related types of modification or variants data may reveal non-obvious genotypic or phenotypic information that should be kept private. For example, the bIQ network may be configured to permit a specific given set of minor alleles to be accessible to one set of users and but not to other users. There may even exist a scenario where certain regions of the genome are requested by the genome owner and/or subject to remain private from everyone including the owner and/or subject.

### Data Validation

An evaluation of the data files that are actively transmitted on the network can be made relatively straightforwardly, since in an exemplary embodiment the data is transmitted over the network in a common format.

In one embodiment a mechanism is created to coordinate the validation process. Such a mechanism would involve a means to synchronize the sequence data content, information in the header, and the various sources of metadata collected at the various steps in the work-flow of the molecular data. For example, the data that is generated at a BCR is stored in files with metadata information that relates directly to the type of biological specimen that is being used; organ type, tissue type of cell type for example. There are other types of information about the process that was used to prepare the sample or visual properties of specimen or who prepared samples or where and when the preparation was done that might be included in the header space.

The particular specimen is given a unique barcode identification and aliquots are made and used to prepare purified DNA and or RNA sequences. Raw sequence reads are generated from the sequencing machines are mapped to a reference as BAM files. In one embodiment these alignment files also contain their own header information as a part of the format that is validated during ingestion into the bIQ network. In such an embodiment it may be advantageous to implement a network-wide data file validation protocol. For example, if the file is corrupted or if required information is omitted from the header, then the destination performing the file upload procedure will be prompted with an error message indicating that the data to be uploaded is not valid. Possible reasons for the invalidity of the data may be included within such error message.

In this scheme, invalid sequence data is not uploaded from the GSCs and therefore not included in data analysis at a GDAC. In one embodiment a straightforward validation process is utilized; namely, files that are not consistent with the standard encode format will not be ingested. In this embodiment the bIQ network accommodates only properly formatted and encrypted files for transactions.

Specific details are given in the above description to provide a thorough understanding of the embodiments. However, it is understood that the embodiments may be practiced without these specific details. For example, circuits or other apparatus may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the claims.

1. A genome storage repository, comprising:
a data repository;
a receive interface for receiving, from over a network, a plurality of portions of at least one file of biological sequence data conveyed over the network in accordance with a parallel file transfer process; and
a controller in communication with the receive interface and the data repository, the controller generating a reconstructed file of biological sequence data by reconstructing the at least one file of biological sequence data using the plurality of portions of the at least one file of biological sequence data.

2. The genome storage repository of claim 1 wherein each of the plurality of portions of the at least one file of biological sequence data are encrypted using an encryption key specific to the parallel file transfer process, the controller using the encryption key to decrypt each of the plurality of portions of the at least one file of biological sequence data.

3. The genome storage repository of claim 1 wherein the controller is further configured to store the at least one file of biological sequence data in the data repository as a plurality of biological data units, each of the plurality of biological data units including a header and a payload including one or more instructions representative of biological sequence information encoded relative to a reference sequence.

4. The genome storage repository of claim 3 wherein the header of each biological data unit includes biological information relevant to the biological sequence data represented by the payload of the biological data unit.

5. The genome storage repository of claim 4 wherein the header of a first of the plurality of biological data units includes DNA-related information and the header of a second of the plurality of biological data units includes RNA-related information.

6. The genome storage data repository of claim 3 wherein the controller is configured to retrieve ones of the plurality of biological data units from the data repository and provide the ones of the plurality of biological data units to a transmit interface for transmission to a subscriber device.

7. The genome storage data repository of claim 6 wherein the transmit interface is operative to transmit the ones of the plurality of biological data units pursuant to a parallel file transfer process.

8. The genome storage data repository of claim 6 wherein the controller is further configured to encrypt the ones of the ones of the plurality of biological data units using a subscriber key unique to the subscriber device.

9. The genome storage data repository of claim 8 wherein the controller is further configured to encrypt the ones of the ones of the plurality of biological data units using a transfer key unique to a transfer session associated with the parallel file transfer process.

10. (canceled)

11. (canceled)

12. (canceled)

13. (canceled)

14. (canceled)

15. (canceled)

16. (canceled)

17. A genome storage repository, comprising:
a data repository containing encoded genomic information and biological information relating to the encoded genomic information;
a controller for generating a plurality of data units containing the encoded genomic information and the biological information; and
a transmit interface for transferring the plurality of data units to a subscriber device over a network.

18. The genome storage repository of claim 17 wherein the encoded genomic information represents genomic information encoded relative to a reference sequence.

19. The genome storage repository of claim 17 wherein one of the plurality of data units includes a payload containing the encoded genomic information and a plurality of headers containing the biological information.

20. The genome storage repository of claim 17 wherein the transmit interface is operative to transmit the plurality of data units pursuant to a parallel file transfer process.

21. The genome storage repository of claim 20 wherein the controller is further configured to encrypt the plurality of data units using a subscriber key unique to the subscriber device.

22. The genome storage repository of claim 21 wherein the controller is further configured to encrypt the plurality of data units using a transfer key unique to a transfer session associated with the parallel file transfer process.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. A method, comprising:
receiving, from over a network, a plurality of portions of at least one file of biological sequence data conveyed over the network in accordance with a parallel file transfer process wherein ones of the plurality of portions are transferred substantially simultaneously in multiple data streams;
generating a reconstructed file of biological sequence data by reconstructing the at least one file of biological sequence data using the plurality of portions of the at least one file of biological sequence data; and
storing the at least one file of biological sequence data in a data repository.

37. The method of claim 36 wherein each of the plurality of portions of the at least one file of biological sequence data are encrypted using an encryption key specific to the parallel file transfer process, the method further including using the encryption key to decrypt each of the plurality of portions of the at least one file of biological sequence data.

38. The method of claim 36 wherein the storing further includes storing the at least one file of biological sequence data in the data repository as a plurality of biological data units, each of the plurality of biological data units including a header and a payload including one or more instructions representative of biological sequence information encoded relative to a reference sequence.

39. The method of claim 38 wherein the header of each biological data unit includes biological information relevant to the biological sequence data represented by the payload of the biological data unit.

40. The method of claim 39 wherein the header of a first of the plurality of biological data units includes DNA-related information and the header of a second of the plurality of biological data units includes RNA-related information.

41. The method of claim 38 further including retrieving ones of the plurality of biological data units from the data repository and transmitting the ones of the plurality of biological data units to a subscriber device.

42. The method of claim 41 wherein the transmitting is performed pursuant to a parallel file transfer process involving a plurality of parallel data streams.

43. The method of claim 41 further including encrypting the ones of the ones of the plurality of biological data units using a subscriber key unique to the subscriber device.

44. The method of claim 43 further including encrypting the ones of the ones of the plurality of biological data units using a transfer key unique to a transfer session associated with the parallel file transfer process.

45. (canceled)

46. (canceled)

47. (canceled)

48. (canceled)

49. (canceled)

50. (canceled)

51. (canceled)

52. A method, comprising:
establishing a data repository containing encoded genomic information and biological information relating to the encoded genomic information;
generating a plurality of data units containing the encoded genomic information and the biological information; and
transferring the plurality of data units to a subscriber device over a network.

53. The method of claim 52 wherein the encoded genomic information represents genomic information encoded relative to a reference sequence.

54. The method of claim 52 wherein one of the plurality of data units includes a payload containing the encoded genomic information and a plurality of headers containing the biological information.

55. The method of claim 52 wherein the transferring includes transmitting the plurality of data units pursuant to a parallel file transfer process.

56. The method of claim 55 further including encrypting the plurality of data units using a subscriber key unique to the subscriber device.

57. The method of claim 56 further including encrypting the plurality of data units using a transfer key unique to a transfer session associated with the parallel file transfer process.

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. The genome storage repository of claim 1 wherein the receive interface is further configured to receive, from an analysis center, a request to process the at least one file of biological sequence data in accordance with an analysis program and wherein the controller is configured to execute instructions of the analysis program so as to generate analysis results for sending to the analysis center.

72. The genome storage repository of claim 71 wherein the receive interface is further configure to receive the analysis program from the analysis center.

73. The genome storage repository of claim 17 further including a receive interface configured to receive, from an analysis center, a request to process the encoded genomic information in accordance with an analysis program and wherein the controller is configured to execute instructions of the analysis program so as to generate analysis results for sending to the analysis center via the transmit interface.

74. The genome storage repository of claim 73 wherein the receive interface is further configure to receive the analysis program from the analysis center.

75. The node of claim 23 wherein the receive interface is further configured to receive, from an analysis center, a request to process the plurality of data units in accordance with an analysis program and wherein the controller is configured to execute instructions of the analysis program so as to generate analysis results for sending to the analysis center.

76. The node of claim 75 wherein the receive interface is further configure to receive the analysis program from the analysis center.

77. A genome storage repository, comprising:
a data repository containing encoded genomic information and biological information relating to the encoded genomic information;
a receive interface for receiving, from over a network, a processing request from an analysis node; and
a controller operative to process, in response to the processing request, at least the genomic information in accordance with an analysis program in order to generate analysis results.

78. The genome storage repository of claim 77 further including a transmit interface configured to transmit the analysis results over the network to the analysis node.

79. The genome storage repository of claim 77 wherein the receive interface is further configured to receive the analysis program from the analysis node.

80. (canceled)

81. (canceled)

82. (canceled)
